(19) United States
(12) Patent Application Publication
(10) Pub. No.: US 2023/0284649 A1
(43) Pub. Date: Sep. 14, 2023

(54) PECTIN-CONTAINING PLANT FIBER COMPOSITION FOR PLANT-BASED ICE CREAM

(71) Applicant: Herbstreith & Fox GmbH & Co. KG Pektin-Fabriken, Neuenbürg (DE)

(72) Inventor: Philipp Martin, Werder (Havel) (US)

(21) Appl. No.: 18/040,414

(22) PCT Filed: Jul. 28, 2021
(86) PCT No.: PCT/EP2021/071133

§ 371 Date: Feb. 2, 2023

(30) Foreign Application Priority Data
Aug. 4, 2020 (DE) 10 2020 120 483.3

(51) Int. Cl. A23G 9/42; A23G 9/34; A23L 29/231; A23L 33/21

(52) U.S. Cl. CPC A23G 9/42; A23G 9/34; A23L 29/231; A23L 33/21

(57) ABSTRACT

The present invention relates to a composition which comprises plant fiber, low-esterified, preferably amidated, soluble pectin and high-esterified soluble pectin. In addition, the invention relates to usage of the composition as a semi-finished product in the food industry. Furthermore, the invention relates to ice cream containing the composition according to the invention and to a method of preparing the ice cream.

The present invention relates to a composition comprising plant fiber, low-esterified, preferably amidated, soluble pectin and high-esterified soluble pectin. In addition, the invention relates to the use of the composition as a semi-finished product in the food industry. Furthermore, the invention relates to ice cream comprising the composition according to the invention and to a method of preparing the ice cream.

### BACKGROUND OF THE INVENTION

Ice cream and other food products stored at temperatures below the freezing point of water and intended for immediate subsequent consumption must meet special requirements. For example, ice cream should not melt immediately at higher temperatures and still feel pleasantly creamy in the mouth. The ice cream must also have the best possible consistent quality when regularly refrozen and must often remain stable over long storage periods.

The most important quality parameter for ice cream is texture. The ice cream should be smooth to the touch, which is achieved by ensuring that the solid particles contained in the ice cream are so small that they are not perceived by the senses of the consumer. If, on the other hand, the ice cream has solid particles of a perceptible size, this regularly leads to a negative taste experience in which the ice cream is perceived as rough, icy and/or sandy. The solid particles of a perceptible size are usually ice crystals with a crystal diameter of 55 μm or more.

The size of ice crystals in ice cream and similar frozen foods can be influenced by a variety of factors. Partial melting of the ice crystals and subsequent refreezing of the water causes the ice crystals to grow in size during storage. This effect is particularly pronounced in the case of a heterogeneous ice matrix, since due to water vapor partial pressure differences within the ice matrix, smaller water molecules diffuse to larger ones and thus contribute to the growth of the ice crystals (Ostwald ripening). Another observable effect leading to ice crystal growth during recrystallization is the coalescence of two or more smaller crystals into a larger crystal. Factors that particularly influence the growth of ice crystals during the storage of ice cream and other frozen or highly refrigerated foods are the temperature gradient during production of the food, the storage temperature and, in particular, the temperature fluctuations during storage, the freezing point of the water in the food, the amount of impinged air (air impingement), the water content and the viscosity of the unfrozen serum phase.

Another important quality characteristic of ice cream and other frozen foods is their melt-off behavior or dimensional stability. The melt-off behavior of ice cream depends to a large extent on the recipe and the process parameters, with the viscosity of the ice cream, the proportion of fat and in particular of destabilized fat, the ice crystal morphology, the incorporation of air or nitrogen into the ice cream mass, the sugar content, the water content and the freezing point all having an influence on the melt-off behavior. If the ice cream melts too quickly, a sauce is formed and the ice cream drips, which is perceived as unpleasant. If, on the other hand, the ice cream melts too slowly, this can negatively influence the consumption of the ice cream and lead to an icy taste impression. The trend towards reducing fat, air and sugar in ice cream further complicates the setting of an optimal melt-off behavior.

In order to achieve a good texture and at the same time good melt-off behavior or high dimensional stability, stabilization systems are used that bind liquid water and increase the serum viscosity of the unfrozen phase. High demands are placed on these stabilization systems. On the one hand, the stabilization systems must improve the texture and the melt-off behavior or the dimensional stability. On the other hand, the stabilization systems must be easy to incorporate, have a neutral taste, be low in calories, have high temperature stability, be stable in storage and as inexpensive as possible. Another factor that has become increasingly important in recent years is clean labeling. Clean labeling is about avoiding as much as possible ingredients with so-called E-numbers that are subject to mandatory labeling. Consumers are paying more and more attention to the ingredients of foods and increasingly want the lowest possible proportion of ingredients that require labeling, such as colorants, preservatives, flavorings and flavor enhancers. Consequently, stabilization systems should contain as few different ingredients requiring labeling as possible.

Hydrocolloids such as locust bean gum (E410), guar gum (E412), sodium alginate (E401), carboxymethyl cellulose (E466-468), xanthan gum (E415), carrageenan (E407), gelatin or native starches are commonly used as stabilization systems for ice cream. The use of a combination of locust bean gum and guar gum to stabilize ice cream is particularly common.

However, with the stabilization systems commonly used today for ice cream and similar frozen foods, it is not yet possible to achieve an optimum combination of pleasant texture, high dimensional stability and good melt-off behavior.

The present invention thus sets itself the task of providing a composition which is suitable for stabilizing ice cream and which improves on the prior art or offers an alternative to it.

This objective is solved by the composition according to claim 1, the use of the composition according to claim 14, the ice cream according to claim 15 and the method of preparing the ice cream according to claim 20.

Preferred embodiments of the invention are found in the dependent Claims and are explained below.

### SUMMARY OF THE INVENTION

The invention relates to a composition comprising plant fiber, low-esterified soluble pectin, high-esterified soluble pectin and optionally sugar.

Surprisingly, it has been shown that such a composition can be used to stabilize ice cream and other frozen foods suitable for direct consumption. When the composition according to the invention is used to stabilize ice cream or other frozen foods suitable for direct consumption, improved storage stability is obtained with good control over the ice crystal size.

With the composition according to the invention, the melt-off rate of ice cream is reduced, so that the ice cream remains stable when exposed to the air even at summer temperatures and still melts pleasantly when consumed.

Another advantage of the composition according to the invention is that it can be present in ice cream in larger amounts than stabilization systems described in the prior art without having a negative influence on the sensory properties of the ice cream.

The composition according to the invention can also be used to achieve optimum flavor and aroma release.

All ingredients of the composition according to the invention are derived from plants and preferably from fruits and thus represent natural ingredients with known positive properties. Moreover, in this way the composition according to the invention represents a vegan semi-finished product.

Both plant fibers and pectins are established and accepted in the food industry, so that corresponding compositions can be used immediately and also internationally without lengthy approval procedures.

The basic components listed above are usually obtained from plant processing residues such as citrus or apple pomace. These are available in sufficient quantities and provide a sustainable and ecologically sound source of the basic components present. Notably, both the plant fiber and the pectin can be obtained from the same raw material source. For example, both citrus fiber and citrus pectin with different degrees of esterification can be obtained from citrus pomace. Similarly, both apple fiber and apple pectin with different degrees of esterification can be obtained from apple pomace.

The present composition has the potential of improved consumer acceptance since natural plant-based products are used.

Due to the good compatibility of the different components of the composition according to the invention, a homogeneous and particularly uniform product is obtained in this way.

Without wishing to be bound to any particular scientific theory, the surprising stabilizing effect of the composition according to the invention seems to be due to the fact that the combination of soluble pectins and insoluble plant fiber achieves a high serum viscosity of the unfrozen serum phase in the frozen food, by which the movement of ice crystals towards each other is slowed down. In this way, the growth of ice crystals is slowed down in the recrystallization phase that takes place permanently during storage. The insoluble plant fiber also settles at individual points between the ice crystals and thus prevents them from growing together to form larger ice crystals (coalescence). It is assumed that the insoluble plant fibers also create steric hindrances that slow down melting. At the same time, the plant fibers are not perceived by the senses during the consumption of ice cream or other frozen foods suitable for direct consumption.

### THE INVENTION IN DETAIL

The composition according to the invention comprises as basic components plant fiber, low-esterified soluble pectin and high-esterified soluble pectin. Here, the low-esterified soluble pectin is preferably a low-esterified amidated soluble pectin.

Thus, the composition according to the invention contains a total of three pectin sources, of which two pectins are soluble and are present as low-esterified, preferably amidated, and high-esterified pectin separate from the plant fibers, respectively, and the third pectin source is the plant fiber, which also contains water-soluble pectin in addition to the insoluble fiber-bound pectin (also referred to as protopectin). Protopectins are insoluble pectins and probably not pure homoglycans. In protopectin, the polygalacturonic acid chains are connected by complex bonds with divalent cations, via ferulic acid groups and borate complexes, and via glycosidic bonds, with neutral sugar side chains, which may consist of arabinose, galactose, xylose, mannose, and traces of fucose. Since the plant fiber also contains water-soluble pectin, as explained above, it is also referred to as “pectin-containing plant fiber” in the context of the invention.

According to a further embodiment, the composition according to the invention consists substantially of plant fiber, low-esterified, preferably amidated, soluble pectin and high-esterified soluble pectin. Here, “substantially” means that the composition contains at most 5 wt. %, preferably at most 4 wt. %, especially at most 3 wt. %, further preferably at most 1 wt. % of other components. According to another embodiment, the composition according to the invention comprises plant fiber, low-esterified, preferably amidated, soluble pectin and high-esterified soluble pectin.

According to another preferred embodiment, the composition according to the invention consists substantially of plant fiber, low-esterified, preferably amidated, soluble pectin, high-esterified soluble pectin and sugar. Here, “substantially” means that the composition contains at most 5 wt. %, preferably at most 4 wt. %, preferably at most 3 wt. %, further preferably at most 1 wt. % of other components. According to another embodiment, the composition according to the invention comprises plant fiber, low-esterified, preferably amidated, soluble pectin, high-esterified soluble pectin and sugar.

The plant fiber is preferably a plant fiber containing protopectin. According to a preferred embodiment of the composition according to the invention, the plant fiber is selected from the group comprising citrus fiber, apple fiber, sugar beet fiber, carrot fiber and pea fiber. These plant fibers have been found to be particularly suitable because they do not affect the sensory properties of the ice cream and are present in the respective plants in sufficient quantity for easy extraction.

In a particularly preferred embodiment, the plant fiber is a citrus fiber or an apple fiber. Citrus and apple fibers are particularly inexpensive to obtain and can be readily incorporated into food products. In addition, due to the specific unfolding of the citrus and apple fibers, the melt-off behavior of the ice cream can be particularly well controlled.

Citrus fibers can be obtained from a wide range of citrus fruits. In a non-restrictive manner, the following examples are mentioned: mandarin (Citrus reticulata), clementine (Citrus x aurantium clementine group, syn.: Citrus clementina), satsuma (Citrus x aurantium satsuma group, syn.: Citrus unshiu), mangshan (Citrus mangshanensis), orange (Citrus x aurantium orange group, syn.: Citrus sinensis), bitter orange (Citrus x aurantium bitter orange group), bergamot (Citrus x limon bergamot group, syn.: Citrus bergamia), shaddock (Citrus maxima), grapefruit (Citrus x aurantium grapefruit group, syn.: Citrus paradisi) pomelo (Citrus x aurantium pomelo group), true lime (Citrus x aurantiifolia), common lime (Citrus x aurantiifolia, syn. Citrus latifolia), kaffir lime (Citrus hystrix), Rangpur lime (Citrus x jambhiri), lemon (Citrus x limon lemon group), citron (Citrus medica) and kumquats (Citrus japonica, syn.: Fortunella). Preferred are orange (Citrus x aurantium orange group, syn.: Citrus sinensis) and lemon (Citrus x limon lemon group).

Apple fiber can be obtained from all cultivated apples (malus domesticus) known to the person skilled in the art. Advantageously, processing residues of apples can be used here as starting material. Accordingly, apple peel, core, seeds or fruit flesh or a combination thereof can be used as starting material. In a preferred manner, apple pomace is used as starting material, i.e. the pressing residues of apples, which typically also contain the abovementioned components in addition to the peels.

According to a preferred embodiment, the sugar-containing composition contains the plant fiber in a proportion of from 20 to 50 wt. %, preferably from 30 to 40 wt. %, and particularly preferably from 34 to 36 wt. %, based on the total weight of the composition. Preferred proportions of plant fiber, based on the total weight of the composition, are thus 30%, 31%, 32%, 33%, 34%, 35%, 36%, 37%, 38%, 39% or 40%, with 34%, 35% or 36% being particularly preferred, these being percentages by weight. Such a proportion of plant fibers in the composition according to the invention ensures particularly good processability and consistency of the composition. In addition, ice cream containing a composition with such a proportion of plant fibers exhibits a particularly good texture and particularly advantageous melt-off behavior. If a proportion of less than 20% by weight of plant fiber is used, larger ice crystals may form in the ice cream at high temperatures. On the other hand, if a proportion of plant fiber of more than 50 wt. % is used, this can lead to increased melting in certain formulations.

The composition according to the invention also contains low-esterified, preferably amidated, soluble pectin. In principle, the low-esterified, preferably amidated, soluble pectin can be obtained here from various plant sources, with apple pomace, beet pulp and citrus peel being particularly advantageous due to their high pectin content. Due to the high pectin content in citrus peels, it has been found to be particularly advantageous if the low-esterified, preferably amidated, soluble pectin is a citrus pectin or an apple pectin.

Accordingly, preferably the sugar-containing composition according to the invention contains the low-esterified, preferably amidated, soluble pectin in a proportion of from 10 to 35 wt. %, preferably from 15 to 30 wt. %, particularly preferably from 20 to 25 wt. % and most preferably 22.5 wt. %, based on the total weight of the composition. Preferred proportions of low-esterified, preferably amidated, soluble pectin, based on the total weight of the composition, are thus 15%, 16%, 17%, 18%, 19%, 20%, 21%, 22%, 23%, 24%, 25%, 26%, 27%, 28%, 29% and 30%, with 20%, 21%, 22.0%, 22.5%, 23.0%, 24% and 25% being particularly preferred, these being percentages by weight. With such a content of low-esterified, preferably amidated, soluble pectin, the viscosity of the unfrozen serum phase in the ice cream can be optimally adjusted and the melt-off behavior optimally controlled.

The composition according to the invention also contains high-esterified soluble pectin. In principle, the high-esterified soluble pectin can be obtained here from various plant sources, with apple pomace, beet pulp and citrus peel being particularly advantageous due to their high pectin content. Due to the high pectin content in citrus peels, it has been found to be particularly advantageous if the high-esterified soluble pectin is a citrus pectin or an apple pectin.

Accordingly, according to an equally preferred embodiment, the sugar-containing composition according to the invention contains the high-esterified soluble pectin, which is preferably a high-esterified soluble citrus pectin or apple pectin, in a proportion of from 5 to 30 wt. %, preferably from 10 to 20 wt. %, particularly preferably from 13 to 17 wt. % and most preferably 15 wt. %, based on the total weight of the composition. Preferred proportions of high-esterified soluble pectin, based on the total weight of the composition, are thus 10%, 11%, 12%, 13%, 14%, 15%, 16%, 17%, 18%, 19%, 20%, with 13%, 14%, 15%, 16%, and 17% being particularly preferred, these being percentages by weight. With such a content of high-esterified soluble pectin, the viscosity of the unfrozen serum phase in the ice cream can be optimally adjusted and the melt-off behavior optimally controlled.

According to another embodiment of the invention, the composition according to the invention additionally contains sugar. According to another embodiment, however, the composition is free of sugar. For certain applications, the use of sugar in the composition according to the invention has been found to be advantageous, since sugar exerts a positive influence on the formation of the structure-providing gel in the unfrozen serum phase. For other applications, it is advantageous if the composition according to the invention is free of sugar, for example if the other components of the foodstuff already contribute a high sugar content.

If the composition according to the invention also contains sugar in addition to the components plant fiber, low-esterified, preferably amidated soluble pectin and high-esterified soluble pectin, it has been found to be advantageous if the sugar is selected from the group consisting of dextrose, sucrose, fructose, invert sugar, isoglucose, mannose, melezitose, glucose, allulose, maltose and rhamnose. These sugars have been found to be particularly compatible with the other ingredients of the composition. Particularly preferred sugars are dextrose or sucrose, with dextrose being the most preferred. Dextrose and sucrose are inexpensive and, in combination with the other components, are excellent for increasing the viscosity of the unfrozen serum phase in ice cream.

In a preferred embodiment, at least a portion of the optionally comprised sugar in the composition is present in the form of a standardizing agent. A “standardizing agent” in the context of the invention is defined as a sugar which, when mixed with the pectin, serves to standardize the pectin. The controlled identical manufacturing processes lead to pectins with predetermined properties. However, due to raw material-related variations within the pectin composition, these pectins are subject to certain variations, e.g. with regard to gel strength or viscosity. The addition of a sugar as a standardizing agent significantly reduces the range of variation and thus standardizes the pectin. This enables a constant dosage from batch to batch. Dextrose and sucrose are preferred as standardizing agents.

If the composition according to the invention contains sugar, the composition preferably contains the sugar in a proportion of from 18 to 40 wt. %, preferably from 20 to 38 wt. % and particularly preferably from 23 to 32 wt. %, based on the total weight of the composition. This sugar content is particularly compatible with the other ingredients of the composition and allows good control of the viscosity properties of the unfrozen serum phase in the ice cream.

According to a preferred embodiment of the invention, the composition has a degree of esterification of from 40 to 60% and preferably from 47 to 50% and/or a degree of amidation of from 5 to 10%, preferably from 6 to 8%, in each case based on the galacturonic acid units of the pectin contained. This combination of properties results in the formation of a dimensionally particularly stable basic structure of the ice cream.

According to one embodiment according to the invention, the sugar-containing composition contains 20 to 50 wt. % of plant fiber, 10 to 35 wt. % of low-esterified, preferably amidated, soluble pectin, 5 to 30 wt. % of high-esterified soluble pectin and 18 to 40 wt. % of sugar, the percentages by weight being based in each case on the total weight of the composition and the sum of all the components of the mixture having to be 100% by weight in each case. At these proportions of the different components, a wide range of different types of ice cream with good texture properties and excellent melt-off behavior can be produced.

According to a preferred embodiment of the invention, the sugar-containing composition contains from 30 to 40 wt. % of plant fiber, from 15 to 30 wt. % of low-esterified, preferably amidated, soluble pectin, from 10 to 20 wt. % of high-esterified soluble pectin, and from 20 to 38 wt. % of sugar, the percentages by weight in each case being based on the total weight of the composition, and the sum of all the components of the mixture in each case having to be 100 wt. %. At these proportions of the different components, a wide range of different types of ice cream with good texture properties and excellent melt-off behavior can be produced.

According to a further embodiment of the invention, the sugar-free composition contains 40 to 60 wt. % plant fiber, 17 to 37 wt. % low-esterified, preferably amidated, soluble pectin and 13 to 33 wt. % high-esterified soluble pectin, wherein the weight percentages in each case refer to the total weight of the composition and wherein the sum of all components of the mixture must in each case be 100 wt. %. At these proportions of the three components, good dimensional stability is achieved.

According to a preferred embodiment of the invention, the sugar-free composition contains 45 to 55 wt. % plant fiber, 22 to 32 wt. % low-esterified, preferably amidated, soluble pectin and 18 to 28 wt. % high-esterified soluble pectin, wherein the weight percentages in each case refer to the total weight of the composition and wherein the sum of all components of the mixture must in each case be 100 wt. %. At these proportions of the three components, particularly good dimensional stability is achieved.

According to a further preferred embodiment, the composition according to the invention consists substantially of plant fiber, low-esterified, preferably amidated, soluble pectin, high-esterified soluble pectin and sugar. Here, “substantially” means that the composition contains at most 5 wt. %, preferably at most 4 wt. %, preferably at most 3 wt. %, further preferably at most 1 wt. % of other components. According to another embodiment, the composition according to the invention comprises plant fiber, low-esterified, preferably amidated, soluble pectin, high-esterified soluble pectin and sugar.

Plant Fiber

In principle, different types of plant fiber can be considered for the composition according to the invention. It has been found to be advantageous if the plant fiber used has one or more of the following properties, since the composition is then particularly suitable for use in a chilled and in particular frozen foodstuff.

According to a preferred embodiment of the composition according to the invention, the plant fiber has a dynamic Weissenberg index in a 2.5 wt. % suspension of more than 4.0, in particular more than 5.0. A plant fiber with such viscoelastic properties makes it possible to obtain a dimensionally particularly stable ice cream with the composition according to the invention. A possible method for determining the dynamic Weissenberg index is described in the examples.

According to a further preferred embodiment, the plant fiber has a dynamic Weissenberg index in a 2.5 wt. % dispersion of more than 5.0, in particular more than 6.0. A plant fiber with such viscoelastic properties makes it possible to obtain a dimensionally particularly stable ice cream with the composition according to the invention. A possible method for determining the dynamic Weissenberg index is described in the examples.

The plant fiber preferably has a viscosity of 100 to 1200 mPas, preferably of 350 to 950 mPas, and particularly preferably of 380 to 850 mPas, wherein the plant fiber is dispersed in water as a 2.5 wt. % solution and the viscosity is measured at a shear rate of 50 s⁻¹ at 20° C.

For determining viscosity, the plant fiber is dispersed in demineralized water as a 2.5 wt. % solution using the method disclosed in the examples, and the viscosity is determined at 20° C. and four shear sections (first and third sections=constant profile; second and fourth sections=linear ramp; measurement in each case at a shear rate of 50 s⁻¹) (rheometer; Physica MCR series, measuring bob CC25 (corresponds to Z3 DIN), company Anton Paar, Graz, Austria). A plant fiber with this high viscosity has the advantage that smaller amounts of fiber are required for thickening the end product. In addition, such a fiber produces a particularly creamy texture.

The plant fiber preferably has a water-binding capacity of 20 to 34 g/g, preferably 22 to 30 g/g, and particularly preferably 23 to 28 g/g, where in each case the amount of water that can be bound by one gram of plant fiber is indicated here in grams. Such an advantageously high water-binding capacity results in a high viscosity and also requires less plant fibers for a sufficiently creamy texture. The water-binding capacity is determined by allowing a sample of a plant fiber to swell in water for a certain period of time, preferably for 24 hours, and then determining the weight of the swollen plant fiber after centrifugation and separation of the supernatant water. A detailed specification of the test method is given in the embodiments.

According to an advantageous embodiment of the composition according to the invention, the plant fiber has a strength of more than 50 g. At such a strength, the composition exhibits high dimensional stability. A possible method of determining the strength of a plant fiber is described in the examples.

According to a preferred embodiment, the plant fiber has a moisture content of less than 15%, preferably less than 10%, and particularly preferably less than 8%. Due to the low moisture content of the plant fiber, the fiber has good swelling characteristics. The moisture of the plant fiber can be determined by mass reduction after drying, preferably by infrared drying with a moisture analyzer, for example the Sartorius® MA-45 moisture analyzer. A detailed specification of the test method is given in the examples of embodiment.

According to a preferred embodiment of the composition according to the invention, the plant fiber as a 1 wt. % aqueous suspension has a pH of from 3.0 to 5.0 and preferably from 3.4 to 4.6. At this pH, the pectin preferably contained in the plant fiber is present in a particularly stable form.

According to a preferred embodiment, the plant fiber has a particle size in which at least 90% of the particles are smaller than 300 μm. A plant fiber with such a small particle size results in a particularly pleasant and homogeneous texture of the ice cream and is particularly easy to process. The particle size can be determined here by means of a sieve machine with a set of sieves with different mesh sizes. A detailed specification of the test method is given in the examples of embodiment.

The plant fiber is preferably substantially colorless and advantageously has no appreciable influence on the color of the product. In this regard, it has been found to be advantageous that in the case of an apple fiber as the plant fiber, the apple fiber has a lightness value of L*>61. If a citrus fiber is used as a plant fiber, it is advantageous if this citrus fiber has a lightness value of L*>88. This means that the citrus fiber is virtually colorless and does not cause any significant discoloration of the products when used in food products such as ice cream. The lightness can be determined by means of chromameter. A detailed specification of the test method is given in the embodiments.

Preferably, the plant fiber has a dietary fiber content of 80 to 95 wt. %, based on the total weight of the plant fiber. With such a high dietary fiber content, the plant fiber contributes only a minimum to the calorie content of the food product and thus allows the production of low-calorie ice cream.

According to one embodiment, the plant fiber in the composition according to the invention is a depectinized plant fiber, preferably a depectinized fruit fiber. When reference is made herein or elsewhere to a “depectinized fiber”, it is intended that the content of pectin in the fiber has been lowered compared to the fiber in its original form. This is done, for example, by an acidic extraction step. In the acidic extraction step, the pectin content of the plant fiber is greatly reduced, so that the plant fiber has less than 10%, preferably less than 8% and particularly preferably less than 6% of water-soluble pectin. This residual pectin is usually high-esterified pectin.

The depectinized plant fiber, which is preferably a depectinized fruit fiber, advantageously has a content of water-soluble pectin of between 2 wt. % and 8 wt. %, and more preferably between 2% and 6% by weight. For example, the content of water-soluble pectin in this plant or fruit fiber may be 2 wt. %, 3 wt. %, 4 wt. %, 5 wt. %, 6 wt. %, 7 wt. %, 8 wt. %, 9 wt. % or 9.5 wt. %.

Particularly preferred plant fibers for the composition according to the invention are selected from the group consisting of activated pectin-containing citrus fiber, partially-activated, activatable pectin-containing citrus fiber, activated pectin-containing apple fiber, and mixtures thereof. The preferred properties of these aforementioned plant fibers are described below. The three mentioned plant fibers with the following preferred properties have been found to be excellent fibers for forming ice cream.

Activated Citrus Fiber Containing Pectin

In one embodiment, the plant fiber used is an activated pectin-containing citrus fiber. Acidic disintegration as a process step in the production process allows the fiber structure to be broken down, and subsequent alcohol washing steps with gentle drying can help maintain this structure accordingly.

In the acidic extraction step, the pectin content of the activated pectin-containing citrus fiber is greatly reduced, so that this citrus fiber has less than 10%, preferably less than 8% and particularly preferably less than 6% of water-soluble pectin. Advantageously, the activated pectin-containing citrus fiber has a content of water-soluble pectin between 2 wt. % and 8 wt. % and, particularly preferably, of between 2 wt. % and 6 wt %. For example, the content of water-soluble pectin in this citrus fiber may be 2 wt. %, 3 wt. %, 4 wt. %, 5 wt. %, 6 wt. %, 7 wt. %, 8 wt. %, 9 wt. % or 9.5 wt. %.

In one embodiment, the activated pectin-containing citrus fiber has, in a 2.5 wt. % suspension, a yield point II (rotation) greater than 1.5 Pa and advantageously greater than 2.0 Pa. Accordingly, in a fiber dispersion, the activated pectin-containing citrus fiber has a yield point I (rotation) of more than 5.5 Pa and advantageously of more than 6.0 Pa.

According to a further embodiment, the activated pectin-containing citrus fiber has, in a 2.5 wt. % suspension, a yield strength II (cross-over) of more than 1.2 Pa and advantageously of more than 1.5 Pa. In a fiber dispersion, the activated pectin-containing citrus fiber has a yield strength I (cross-over) of greater than 6.0 Pa and advantageously of greater than 6.5 Pa.

In one embodiment, the activated pectin-containing citrus fiber has a dynamic Weissenberg index in the fiber suspension of more than 7.0, advantageously of more than 7.5 and particularly advantageously of more than 8.0. Accordingly, after shear activation, the activated pectin-containing citrus fiber has a dynamic Weissenberg index in the fiber dispersion of more than 6.0, advantageously of more than 6.5 and particularly advantageously of more than 7.0.

According to an advantageous embodiment, the activated pectin-containing citrus fiber has a strength of at least 150 g, particularly advantageously of at least 220 g, in a 4 wt. % aqueous suspension.

Preferably, the activated pectin-containing citrus fiber has a viscosity of at least 650 mPas, wherein the pectin-containing citrus fiber is dispersed in water as a 2.5 wt. % solution and the viscosity is measured at a shear rate of 50 s⁻¹ at 20° C.

For determining viscosity with the method disclosed in the examples, the activated pectin-containing citrus fiber is dispersed in demineralized water as a 2.5 wt. % solution and the viscosity is determined at 20° C. and four shear sections (first and third section=constant profile; second and fourth section=linear ramp; measurement in each case at a shear rate of 50 s⁻¹) (rheometer; Physica MCR series, measuring bob CC25 (corresponds to Z3 DIN), Anton Paar, Graz, Austria). A pectin-containing citrus fiber with this high viscosity has the advantage that smaller amounts of fiber are required for thickening the end product. In addition, the fiber thus produces a creamy texture.

The activated pectin-containing citrus fiber advantageously has a water-binding capacity of more than 22 g/g. Such an advantageously high water binding capacity leads to a high viscosity and therefore also to lower fiber consumption with a creamy texture.

According to one embodiment, the activated pectin-containing citrus fiber has a moisture content of less than 15%, preferably less than 10% and particularly preferably less than 8%.

It is also preferred that the activated pectin-containing citrus fiber in 1.0% aqueous suspension has a pH of from 3.1 to 4.75 and preferably from 3.4 to 4.2.

Advantageously, the activated pectin-containing citrus fiber has a particle size in which at least 90% of the particles are smaller than 250 μm, preferably smaller than 200 μm and in particular smaller than 150 μm.

According to an advantageous embodiment, the activated pectin-containing citrus fiber has a lightness value L*>90, preferably of L*>91 and particularly preferably of L*>92. This means that the citrus fibers are virtually colorless and do not lead to any appreciable discoloration of the products when used in food products.

Advantageously, the activated pectin-containing citrus fiber has a dietary fiber content of 80 to 95%.

The activated pectin-containing citrus fiber used according to the invention is preferably available in powder form. This has the advantage of providing a formulation with low weight and high storage stability, which can also be used in a simple manner in terms of process technology. This formulation is only made possible by the activated pectin-containing citrus fiber used in accordance with the invention, which, unlike modified starches, does not tend to form lumps when stirred into liquids.

By the acidic extraction step, the pectin content of the citrus fiber has been greatly reduced, so that the activated pectin-containing citrus fiber has less than 10%, preferably less than 8% and particularly preferably less than 6% of water-soluble pectin. This residual pectin is high-esterified pectin. According to the invention, a high-esterified pectin is understood to be a pectin which has a degree of esterification of at least 50%. The degree of esterification describes the percentage of carboxyl groups in the galacturonic acid units of the pectin which are present in esterified form, e.g. as methyl esters. The degree of esterification can be determined using the method according to JECFA (Monograph 19-2016, Joint FAO/WHO Expert Committee on Food Additives).

Preparation of the Activated Pectin-Containing Citrus Fiber

The activated pectin-containing citrus fiber is obtainable by a method comprising the following steps:
(a) providing a raw material containing cell wall material of an edible citrus fruit;
(b) disintegrating the raw material by incubating an aqueous suspension of the raw material at an acidic pH;
(c) separating the disintegrated material from step (b) from the aqueous suspension in one or more steps;
(d) washing the material separated in step (c) with an aqueous solution and separating coarse or non-disintegrated particles;
(e) separating the washed material from step (d) from the aqueous solution;
(f) washing the separated material from step (e) at least twice with an organic solvent and subsequently separating the washed material from the organic solvent each time;
(g) optionally additionally removing the organic solvent by contacting the washed material from step (f) with water vapor;
(h) drying the material from step (f) or (g) comprising vacuum drying to obtain the pectin-containing citrus fiber.

This manufacturing process results in citrus fibers with a large internal surface area, which also increases the water binding capacity and is associated with good viscosity formation.

These fibers are activated fibers that have sufficient strength in an aqueous suspension so that no additional shear forces are required in the application for the user to obtain the optimum rheological properties such as viscosity or texturing. The activated pectin-containing citrus fiber is referred to synonymously as pectin-containing citrus fiber in the context of the application.

The inventors have found the citrus fibers produced by this method to exhibit good rheological properties. The fibers according to the invention can be easily rehydrated and the advantageous rheological properties are retained even after rehydration.

The manufacturing process described above results in citrus fibers that are highly neutral in taste and aroma and are therefore advantageous for food applications. The inherent flavor of the other ingredients is not masked and can therefore develop optimally.

The citrus fibers to be used according to the invention are obtained from citrus fruits and are thus natural ingredients with known positive properties.

Citrus fruits and preferably processing residues from citrus fruits can be used as raw material. Accordingly, citrus peel (and here albedo and/or flavedo), citrus vesicles, segmental membranes or a combination thereof may be used as raw material for use in the process. In a preferred manner, the raw material used is citrus pomace, i.e., the press residues of citrus fruits, which typically contain the pulp in addition to the peels.

Acidic disintegration in step (b) of the method serves to remove pectin by converting the protopectin into soluble pectin and simultaneously activating the fiber by increasing the internal surface area. Furthermore, the pulping process thermally comminutes the raw material. Acidic incubation in an aqueous environment under the action of heat causes it to disintegrate into citrus fibers. Thermal comminution is thus achieved, and a mechanical comminution step is thus not necessary as part of the manufacturing process. This represents a decisive advantage over conventional fiber production processes, which, in contrast, require a shearing step (such as (high) pressure homogenization) to obtain a fiber with adequate rheological properties.

Acidic disintegration as method step (b) in the manufacturing method allows the fiber structure to be broken down, and subsequent alcohol washing steps with gentle drying can help to maintain this structure accordingly.

The raw material is present as an aqueous suspension during the disintegration in step (b). According to the invention, a suspension is a heterogeneous mixture of a liquid and finely dispersed solids (raw material particles). Since the suspension tends to sedimentation and phase separation, the particles are suitably kept in suspension by shaking or stirring. Thus, there is no dispersion in which the particles are broken up by mechanical action (shear) so that they are finely dispersed.

To obtain an acidic pH in step (b), the person skilled in the art can make use of any acid or acidic buffer solution known to him. For example, an organic acid such as citric acid may be used.

Alternatively, or in combination, a mineral acid can also be used. Examples include sulfuric acid, hydrochloric acid, nitric acid or sulfuric acid. Preferably, nitric acid is used.

In the acid disintegration in step (b) of the method, the pH of the suspension is between pH=0.5 and pH=4.0, preferably between pH=1.0 and pH=3.5, and particularly preferably between pH=1.5 and pH=3.0.

According to the invention, the liquid for preparing the aqueous suspension comprises more than 50 vol %, preferably more than 60, 70, 80 or even 90 vol %, of water. In a preferred embodiment, the liquid contains no organic solvent and in particular no alcohol. Thus, there is water-based acidic extraction.

In one embodiment, no enzymatic treatment of the raw material by addition of an enzyme, in particular no amylase treatment, takes place in the production process and in particular in the acidic disintegration in step (b).

The incubation in the acidic disintegration in step (b) is carried out at a temperature between 60° C. and 95° C., preferably between 70° C. and 90° C. and particularly preferably between 75° C. and 85° C.

The incubation in step (b) is carried out for a period of time between 60 min and 8 hours and preferably between 2 and 6 hours.

The aqueous suspension suitably has a dry weight of between 0.5 wt. % and 5 wt. %, preferably between 1 wt. % and 4 wt. %, and particularly preferably between 1.5 wt. % and 3 wt. % during the acidic disintegration in step (b).

The aqueous suspension is stirred or shaken during the disintegration in step (b). This is preferably done in a continuous manner to keep the particles in suspension.

In step (c) of the method, the disintegrated material is separated from the aqueous solution and thus recovered. This separation is carried out as a single-stage or multi-stage separation.

Advantageously, the disintegrated material is subjected to a multi-stage separation in step (b). Here, it is preferred for the separation from the aqueous suspension to be carried out stepwise to separate increasingly finer particles. This means, for example, that in a two-stage separation, both stages perform a separation of larger particles, with finer particles being separated in the second stage as compared to the first stage in order to achieve a separation of the particles from the suspension which is as complete as possible. Preferably, the first separation of particles is done with decanters and the second separation is done with separators. Thus, the material becomes more and more finely particulate with each separation step.

After acidic disintegration in step (b) and separation of the disintegrated material in step (c), the separated material is washed with an aqueous solution in step (d). Through this step, remaining water-soluble substances, such as sugar, can be removed. Especially the removal of sugar by means of this step helps to make the citrus fiber less adhesive and thus easier to process and use.

In the context of the invention, the “aqueous solution” is understood to be the aqueous liquid used for washing in step (d). The mixture of this aqueous solution and the disintegrated material is referred to as the “wash mixture”.

Advantageously, the washing according to step (d) is carried out with water as the aqueous solution. Particularly advantageous here is the use of deionized water.

In one embodiment, the aqueous solution comprises more than 50 vol %, preferably more than 60, 70, 80 or even 90 vol % of water. In a preferred embodiment, the aqueous solution contains no organic solvent and in particular no alcohol. Thus, there is water-based washing instead of water-alcohol exchange as in the case of fiber washing with a mixture of alcohol and water, this mixture having more than 50 vol % alcohol and typically an alcohol content of more than 70 vol %.

Alternatively, a salt solution with an ionic strength of I<0.2 mol/l can be used as the aqueous solution.

The washing according to step (d) is advantageously carried out at a temperature between 30° C. and 90° C., preferably between 40° C. and 80° C. and particularly preferably between 50° C. and 70° C.

The period of contacting with the aqueous solution in step (d) takes place over a period of between 10 min and 2 hours, preferably between 30 min and one hour.

During washing according to step (d), the dry matter in the wash mixture is between 0.1 wt. % and 5 wt. %, preferably between 0.5 wt. % and 3 wt. %, and more preferably from between 1 wt. % and 2 wt. %.

More advantageously, washing according to step (d) is carried out with mechanical agitation of the wash mixture. This is more conveniently done by stirring or shaking the wash mixture.

During washing, step (d) involves separation of coarse or non-disintegrated particles. Advantageously, this involves separation of particles with a particle size of more than 500 μm, more preferably of more than 400 μm and most preferably of more than 350 μm.

The separation is advantageously carried out by wet sieving. A straining machine or belt press can be used for this purpose. This removes both coarse particulate impurities and insufficiently disintegrated material from the raw material.

After washing with the aqueous solution, the washed material is separated from the aqueous solution according to step (e). This separation is advantageously carried out with a decanter or a separator.

In step (f), a further washing step is then carried out; this time, however, with an organic solvent. This involves washing at least twice with an organic solvent.

The organic solvent can also be used in a mixture of the organic solvent and water, in which case this mixture has more than 50% by volume of organic solvent and preferably more than 70% by volume of organic solvent.

The organic solvent in step (f) is advantageously an alcohol which may be selected from the group consisting of methanol, ethanol and isopropanol.

The washing step is carried out at a temperature between 40° C. and 75° C., preferably between 50° C. and 70° C., and more preferably between 60° C. and 65° C.

The period of contacting with the organic solvent in step (f) takes place over a period of between 60 min and 10 h and preferably of between 2 h and 8 h.

Each washing step with the organic solvent comprises contacting the material with the organic solvent for a certain period of time followed by separation of the material from the organic solvent. A decanter or a press is preferably used for this separation.

During washing with the organic solvent in step (f), the dry matter in the washing solution is between 0.5 wt. % and 15 wt. %, preferably between 1.0 wt. % and 10 wt. %, and particularly preferably between 1.5 wt. % and 5.0 wt. %

Washing with the organic solvent in step (f) is preferably carried out with mechanical agitation of the wash mixture. Preferably, the washing is carried out in a vessel with agitator.

During washing with the organic solvent in step (f), advantageously, a device for homogenization of the suspension is used. This device is preferably a toothed-ring disperser.

According to an advantageous embodiment, washing with the organic solvent in step (f) is carried out in a countercurrent process.

According to one embodiment, washing with the organic solvent in step (f) involves partial neutralization by addition of Na or K salts, NaOH or KOH.

During washing with the organic solvent in step (f), an additional decoloring of the material can also be carried out. This decoloring can be performed by adding one or more oxidizing agents. These can be, for example, chlorine dioxide and hydrogen peroxide, which can be used alone or in combination.

According to an advantageous embodiment, during the at least two-fold washing with an organic solvent in step (f), the final concentration of the organic solvent in the solution increases with each washing step. This incrementally increasing amount of organic solvent reduces the amount of water in the fiber material in a controlled manner, so that the rheological properties of the fibers are maintained during the subsequent solvent removal and drying steps and no collapse of the activated fiber structure occurs.

Preferably, the final concentration of organic solvent in step (f) is between 60 and 70% by volume in the first washing step, between 70 and 85% by volume in the second washing step, and between 80 and 90% by volume in an optional third washing step.

According to the optional step (g), the solvent can additionally be reduced by bringing the material in contact with water vapor. This is preferably done with a stripper, in which the material is brought in contact with water vapor as a stripping gas in countercurrent.

In step (h), drying of the washed material from step (f) or of the stripped material from step (g) is performed, wherein drying comprises vacuum drying and preferably consists of vacuum drying. In vacuum drying, the washed material as the dry material is subjected to a negative pressure, which lowers the boiling point and thus leads to evaporation of water even at low temperatures. The heat of evaporation, which is continuously extracted from the dry material, is suitably replenished from the outside until the temperature remains constant. Vacuum drying has the effect of lowering the equilibrium vapor pressure, which promotes capillary transport. This has proved to be particularly advantageous for the present citrus fiber material, since it preserves the activated open fiber structures and thus the resulting rheological properties. Preferably, vacuum drying is carried out at a negative pressure of less than 400 mbar, preferably less than 300 mbar, further preferably less than 250 mbar and particularly preferably less than 200 mbar.

The drying under vacuum in step (h) is suitably carried out at a shell temperature of between 40° C. and 100° C., preferably of between 50° C. and 90° C. and particularly preferably of between 60° C. and 80° C. Following drying, the product is expediently cooled to room temperature.

According to an advantageous embodiment, after drying in step (h), the method additionally comprises a comminution, grinding or screening step. This step is advantageously designed such that as a result 90% of the particles have a particle size of less than 250 μm, preferably a particle size of less than 200 μm and in particular a particle size of less than 150 μm. At this particle size, the fiber is readily dispersible and has optimum swelling properties.

The activated citrus fiber and a method for the production thereof are disclosed in application DE 10 2020 115 526.3.

Partially Activated, Activatable Pectin-Containing Citrus Fiber

According to an alternative embodiment, a partially activated, activatable citrus fiber containing pectin is used as the plant fiber. Acidic disintegration as a process step in the manufacturing method allows the fiber structure to be broken down, and subsequent alcohol washing steps with gentle drying can be employed to maintain this structure accordingly.

Due to the acidic extraction step, the pectin content of the partially-activated activatable pectin-containing citrus fiber is greatly reduced, so that this citrus fiber has less than 10%, preferably less than 8% and particularly preferably less than 6% of water-soluble pectin. Advantageously, the partially activated activatable citrus fiber has a content of water-soluble pectin between 2 wt. % and 8 wt. % and particularly preferably between 2 and 6 wt. %. The content of water-soluble pectin in this citrus fiber may be, for example, 2 wt. %, 3 wt. %, 4 wt. %, 5 wt. %, 6 wt. %, 7 wt. %, 8 wt. %, 9 wt. % or 9.5 wt. %.

In one embodiment, the partially-activated, activatable pectin-containing citrus fiber has, in a 2.5 wt. % suspension, a yield strength II (rotation) of 0.1-1.0 Pa, advantageously 0.3-0.9 Pa, and particularly advantageously 0.6-0.8 Pa. Accordingly, in a 2.5 wt. % dispersion, the partially activated, activatable pectin-containing citrus fiber has a yield strength I (rotation) of 1.0-4.0 Pa, advantageously of 1.5-3.5 Pa, and particularly advantageously of 2.0-3.0 Pa.

According to a further embodiment, the partially activated, activatable pectin-containing citrus fiber has, in a 2.5 wt. % suspension, a yield strength II (cross-over) of 0.1-1.0 Pa, advantageously of 0.3-0.9 Pa and particularly advantageously of 0.6-0.8 Pa. In a 2.5 wt. % dispersion, the partially activated, activatable pectin-containing citrus fiber has a yield strength I (cross-over) of 1.0-4.5 Pa, advantageously of 1.5-4.0 Pa and particularly advantageously of 2.0-3.5 Pa.

In one embodiment, the partially-activated, activatable pectin-containing citrus fiber has, in a 2.5% suspension, a dynamic Weissenberg index of 4.5-8.0 Pa, advantageously of 5.0-7.5 Pa and particularly advantageously of 7.0-7.5 Pa. After shear activation, the partially-activated, activatable pectin-containing citrus fiber correspondingly has, in a 2.5% by weight dispersion, a dynamic Weissenberg index of 5.0-9.0 Pa, advantageously of 6.0-8.5 Pa and particularly advantageously of more than 7.0-8.0 Pa.

According to an advantageous embodiment, the partially-activated, activatable pectin-containing citrus fiber has a strength, in an aqueous 4 wt. % suspension, of from 60 g to 240 g, preferably from 120 g to 200 g and particularly preferably from 140 to 180 g.

Preferably, the partially activated, activatable pectin-containing citrus fiber has a viscosity of from 150 to 600 mPas, preferably from 200 to 550 mPas, and particularly preferably from 250 to 500 mPas, wherein the partially activated, activatable pectin-containing citrus fiber is dispersed in water as a 2.5 wt. % solution and the viscosity is measured at a shear rate of 50 s⁻¹ at 20° C.

For determining viscosity, the partially activated activatable citrus fiber containing pectin is dispersed in demineralized water by the method disclosed in the Examples as a 2.5 wt. % solution and the viscosity is determined at 20° C. and four shear sections (first and third section=constant profile; second and fourth section=linear ramp; evaluation in each case at a shear rate of 50 s⁻¹) (rheometer; Physica MCR series, measuring bob CC25 (corresponds to Z3 DIN), Anton Paar, Graz, Austria). An activatable citrus fiber with this high viscosity after shear activation has the advantage that smaller amounts of fiber are required for thickening the final product. In addition, the fiber thus produces a creamy texture.

Advantageously, the partially activated, activatable pectin-containing citrus fiber has a water-binding capacity of more than 20 g/g, preferably more than 22 g/g, particularly preferably more than 24 g/g, and especially preferably from 24 to 26 g/g. Such an advantageously high water-binding capacity leads to a high viscosity and consequently also to lower fiber consumption with a creamy texture.

According to one embodiment, the partially activated, activatable pectin-containing citrus fiber has a moisture content of less than 15%, preferably less than 10% and particularly preferably less than 8%.

It is also preferred for the partially-activated, activatable pectin-containing citrus fiber in 1.0 wt. % aqueous suspension to have a pH of from 3.1 to 4.75 and preferably from 3.4 to 4.2.

Advantageously, the partially activated, activatable pectin-containing citrus fiber has a particle size in which at least 90% of the particles are smaller than 450 μm, preferably smaller than 350 μm and in particular smaller than 250 μm.

According to an advantageous embodiment, the partially activated, activatable pectin-containing citrus fiber has a lightness value of L*>84, preferably of L*>86 and particularly preferably of L*>88. This means that the citrus fibers are virtually colorless and do not cause any appreciable discoloration when used in food products.

Advantageously, the partially activated, activatable pectin-containing citrus fiber has a dietary fiber content of 80 to 95%.

The partially activated, activatable pectin-containing citrus fiber used according to the invention is preferably available in powder form. This has the advantage of providing a formulation with low weight and high storage stability, which can also be used in a simple manner in terms of process technology. This formulation is only made possible by the activatable citrus fiber used in accordance with the invention, which, unlike modified starches, does not tend to form lumps when stirred into liquids.

In the acidic extraction step, the pectin content of the partially activated, activatable pectin-containing citrus fiber has been greatly reduced, so that the pectin-containing citrus fiber has less than 10%, preferably less than 8% and particularly preferably less than 6% of water-soluble pectin. This residual pectin is high-esterified pectin. According to the invention, a high-esterified pectin is understood to be a pectin which has a degree of esterification of at least 50%. The degree of esterification describes the percentage of carboxyl groups in the galacturonic acid units of the pectin which are present in esterified form, e.g. as methyl esters. The degree of esterification can be determined using the method according to JECFA (Monograph 19-2016, Joint FAO/WHO Expert Committee on Food Additives).

Preparation of the Partially-Activated Activatable Pectin-Containing Citrus Fiber

The partially-activated, activatable pectin-containing citrus fiber is obtainable by a method comprising the following steps:
(a) providing a raw material comprising cell wall material of an edible citrus fruit;
(b) disintegrating the raw material by incubating an aqueous suspension of the raw material at an acidic pH;
(c) separating the disintegrated material from step (b) from the aqueous suspension in one or more steps;
(d) washing the material separated in step (c) with an aqueous solution and separating coarse or non-disientegrated particles;
(e) separating the washed material from step (d) from the aqueous solution;
(f) washing the separated material from step (e) at least twice with an organic solvent and then separating the washed material from the organic solvent each time;
(g) optionally additionally removing the organic solvent by contacting the washed material from step (f) with water vapor;
(h) drying the material from step (f) or (g), comprising drying at normal pressure to obtain the pectin-containing citrus fiber.

This production method results in citrus fibers with a large internal surface area, which also increases the water binding capacity and is associated with good viscosity formation.

These fibers are activatable fibers that have adequate strength in an aqueous suspension due to partial activation in the production process. However, to obtain the optimum rheological properties such as viscosity or texturing, additional shear forces must be applied by the user. The fibers are thus partially activated fibers, which can, however, be further activated. The activatable pectin-containing citrus fiber is referred to synonymously as “pectin-containing citrus fiber” in the context of the application.

As the inventors have found, the citrus fibers produced by the method described above have good rheological properties. The fibers to be used according to the invention can be easily rehydrated and the advantageous rheological properties are retained even after rehydration.

The production process described above results in citrus fibers that are highly neutral in taste and aroma and are therefore advantageous for food applications. The inherent flavor of the other ingredients is not masked and can therefore develop optimally.

The citrus fibers usable according to the invention are obtained from citrus fruits and thus represent natural ingredients with well-known positive properties.

Citrus fruits and preferably processing residues from citrus fruits can be used as raw material. Accordingly, citrus peel (and here albedo and/or flavedo), citrus vesicles, segmental membranes or a combination thereof may be used as raw material for use in the process. In a preferred manner, the raw material used is citrus pomace, i.e., the press residues of citrus fruits, which typically contain the pulp in addition to the peels.

Acidic disintegration in step (b) of the method serves to remove pectin by converting the protopectin into soluble pectin and simultaneously activating the fiber by enlarging the internal surface area. Furthermore, the pulping process thermally comminutes the raw material. Acidic incubation in an aqueous environment under the action of heat causes it to disintegrate into citrus fibers. Thermal comminution is thus achieved, and a mechanical comminution step is not necessary as part of the production process. This is a decisive advantage over conventional fiber production processes, which, in contrast, require a shearing step (such as by (high) pressure homogenization) to obtain a fiber with adequate rheological properties.

The raw material is available as an aqueous suspension during the disintegration step (b). According to the invention, a suspension is a heterogeneous mixture of substances consisting of a liquid and solids (raw material particles) finely dispersed therein. Since the suspension tends to sedimentation and phase separation, the particles are suitably kept in suspension by shaking or stirring. Thus, there is no dispersion in which the particles are broken up by mechanical action (shear) so that they are finely dispersed.

To obtain an acidic pH in step (b), the person skilled in the art can make use of any acid or acidic buffer solution known to him. For example, an organic acid such as citric acid may be used.

Alternatively, or in combination, a mineral acid can also be used. Examples include sulfuric acid, hydrochloric acid, nitric acid or sulfuric acid. Preferably, nitric acid is used.

In the acidic disintegration in step (b) of the method, the pH of the suspension is between pH=0.5 and pH=4.0, preferably between pH=1.0 and pH=3.5, and particularly preferably between pH=1.5 and pH=3.0.

According to the invention, the liquid for preparing the aqueous suspension comprises more than 50 vol %, preferably more than 60, 70, 80 or even 90 vol % of water. In a preferred embodiment, the liquid contains no organic solvent and in particular no alcohol. Thus, water-based acidic extraction takes place.

In one embodiment, no enzymatic treatment of the raw material by addition of an enzyme, in particular no amylase treatment, takes place in the production process and in particular in the acidic disintegration in step (b).

The incubation during acidic disintegration in step (b) is carried out at a temperature between 60° C. and 95° C., preferably between 70° C. and 90° C. and particularly preferably between 75° C. and 85° C.

The incubation in step (b) is carried out for a period of time between 60 min and 8 hours and preferably between 2 hours and 6 hours.

The aqueous suspension suitably has a dry weight of between 0.5 wt. % and 5 wt. %, preferably between 1 wt. % and 4 wt. %, and particularly preferably between 1.5 wt. % and 3 wt. % during the acidic disintegration in step (b).

The aqueous suspension is stirred or shaken during the disintegration in step (b). This is preferably done in a continuous manner to keep the particles in suspension.

In step (c) of the method, the disintegrated material is separated from the aqueous solution and thus recovered. This separation is carried out as a single-stage or multi-stage separation.

Advantageously, the disintegrated material is subjected to a multi-stage separation in step (c). Here, it is preferred for the separation from the aqueous suspension to be carried out stepwise to separate increasingly finer particles. This means, for example, that in a two-stage separation, both stages perform a separation of larger particles, with finer particles being separated in the second stage compared to the first stage in order to achieve a separation of the particles from the aqueous suspension which is as complete as possible. Preferably, the first separation of particles is done with decanters and the second separation is done with separators. Thus, the material becomes more and more finely particulate with each separation step.

After acidic disintegration in step (b) and separation of the disintegrated material in step (c), the separated material is washed with an aqueous solution in step (d). Through this step, remaining water-soluble substances, such as sugar, can be removed. Especially the removal of sugar by means of this step helps to make the citrus fiber less adhesive and thus easier to process and use.

In the context of the invention, the “aqueous solution” is understood to be the aqueous liquid used for washing in step (d). The mixture of this aqueous solution and the disintegrated material is referred to as the “wash mixture”.

Advantageously, the washing according to step (d) is carried out with water as the aqueous solution. Particularly advantageous here is the use of deionized water.

In one embodiment, the aqueous solution comprises more than 50 vol %, preferably more than 60, 70, 80 or even 90 vol % of water. In a preferred embodiment, the aqueous solution contains no organic solvent and in particular no alcohol. Thus, a water-based wash takes place and no water-alcohol exchange as in the case of fiber washing with a mixture of alcohol and water, this mixture having more than 50 vol % alcohol and typically an alcohol content of more than 70 vol %.

Alternatively, a salt solution with an ionic strength of I<0.2 mol/l can be used as the aqueous solution.

The washing according to step (d) is advantageously carried out at a temperature between 30° C. and 90° C., preferably between 40° C. and 80° C. and particularly preferably between 50° C. and 70° C.

The period of contacting with the aqueous solution in step (d) takes place over a period of between 10 min and 2 hours, preferably between 30 min and one hour.

During washing according to step (d), the dry matter in the wash mixture is between 0.1 wt. % and 5 wt. %, preferably between 0.5 wt. % and 3 wt. %, and particularly preferably from between 1 wt. % and 2 wt. %.

More advantageously, washing according to step (d) is carried out with mechanical agitation of the wash mixture. This is more conveniently done by stirring or shaking the wash mixture.

During washing, step (d) involves a separation of coarse or non-disintegrated particles. Particularly advantageous here is the separation of particles with a particle size of more than 500 μm, more preferably more than 400 μm and most preferably more than 350 μm. The separation is advantageously carried out with a straining machine or a belt press. This removes both coarse particulate impurities and insufficiently disintegrated material from the raw material.

After washing with the aqueous solution in step (d), the washed material is separated from the aqueous solution according to step (e). This separation is advantageously carried out with a decanter or a separator.

In step (f), a further washing step is then carried out, but this time with an organic solvent. This involves washing at least twice with an organic solvent.

The organic solvent can also be used as a mixture of the organic solvent and water, in which case this mixture has more than 50% by volume of organic solvent and preferably more than 70% by volume of organic solvent.

The organic solvent in step (f) is advantageously an alcohol which may be selected from the group consisting of methanol, ethanol and isopropanol.

The washing step in step (f) is carried out at a temperature between 40° C. and 75° C., preferably between 50° C. and 70° C., and particularly preferably between 60° C. and 65° C.

The period of contacting with the organic solvent in step (f) is carried out over a period of time between 60 min and 10 h and preferably between 2 h and 8 h.

Each washing step with the organic solvent comprises contacting the material with the organic solvent for a certain period of time followed by separation of the material from the organic solvent. A decanter or a press is preferably used for this separation.

During washing with the organic solvent in step (f), the dry matter in the washing solution is between 0.5 wt. % and 15 wt. %, preferably between 1.0 wt. % and 10 wt. %, and particularly preferably between 1.5 wt. % and 5.0 wt. %

Washing with the organic solvent in step (f) is preferably carried out with mechanical agitation of the wash mixture. Preferably, the washing is carried out in a vessel with an agitator.

During washing with the organic solvent in step (f), advantageously, a device for homogenization of the suspension is used. This device is preferably a toothed-ring disperser.

According to an advantageous embodiment, washing with the organic solvent in step (f) is carried out in a countercurrent process.

According to one embodiment, washing with the organic solvent in step (f) involves partial neutralization by addition of Na or K salts, NaOH or KOH.

During washing with the organic solvent in step (f), an additional decolorization of the material can also be carried out. This decolorization can be performed by adding one or more oxidizing agents. Exemplary oxidizing agents mentioned here are chlorine dioxide and hydrogen peroxide, which can be used alone or in combination.

According to an advantageous embodiment, during at least two-fold washing with an organic solvent in step (f), the final concentration of the organic solvent in the solution increases with each washing step. This incrementally increasing amount of organic solvent reduces the amount of water in the fiber material in a controlled manner, so that the rheological properties of the fibers are maintained during the subsequent solvent removal and drying steps and no collapse of the partially activated fiber structure occurs.

Preferably, the final concentration of organic solvent in the first washing step is between 60 and 70 vol %, in the second washing step between 70 and 85 vol %, and in an optional third washing step between 80 and 90 vol %.

According to the optional step (g), the solvent can additionally be reduced by bringing the material into contact with water vapor. This is preferably carried out with a stripper, in which the material is brought into contact with water vapor as a stripping gas in countercurrent.

According to an advantageous embodiment, the material is moistened with water before drying according to step (h). This is preferably done by introducing the material into a moistening screw and spraying it with water.

In step (h), drying of the washed material from step (f) or of the stripped material from step (g) is performed, wherein drying comprises drying under normal pressure. Examples of suitable drying processes are fluidized bed drying, belt drying, drum drying or paddle drying. Fluidized bed drying is particularly preferred here. The advantage is that the product is dried in a loosened state, which simplifies the subsequent comminution step. In addition, this type of drying avoids damage to the product by local overheating due to the easily closable heat input.

Drying under normal pressure in step (h) is expediently carried out at a temperature of between 50° C. and 130° C., preferably between 60° C. and 120° C. and particularly preferably between 70° C. and 110° C. Following drying, the product is expediently cooled to room temperature.

According to an advantageous embodiment, after drying in step (h), the method additionally comprises a comminution, grinding or screening step. This step is advantageously performed such that as a result 90% of the particles have a particle size of less than 450 μm, preferably a particle size of less than 350 μm and in particular a particle size of less than 250 μm. At this particle size, the fiber is readily dispersible and exhibits optimum swelling properties.

The partially activated, activatable pectin-containing citrus fiber and a method of its production are disclosed in application DE 10 2020 115 527.1.

Activated Pectin-Containing Apple Fiber

In one embodiment, an activated apple fiber containing pectin is used as the plant fiber. Acidic disintegration as a process step in the manufacturing process allows the fiber structure to be broken down, and subsequent alcohol washing steps with gentle drying can be employed to maintain this structure accordingly.

Due to the acidic extraction step, the pectin content of the activated pectin-containing apple fiber is greatly reduced, so that this apple fiber has less than 10%, preferably less than 8% and particularly preferably less than 6% of water-soluble pectin. Advantageously, the activated pectin-containing apple fiber has a content of water-soluble pectin between 2 wt. % and 8 wt. % and particularly preferably between 2 and 6 wt. %. The content of water-soluble pectin in this apple fiber may be, for example, 2 wt. %, 3 wt. %, 4 wt. %, 5 wt. %, 6 wt. %, 7 wt. %, 8 wt. %, 9 wt. % or 9.5 wt. %.

In one embodiment, the activated pectin-containing apple fiber has, in a 2.5 wt. % suspension, a yield strength II (rotation) of more than 0.1 Pa, advantageously more than 0.5 Pa, and particularly advantageously more than 1.0 Pa. Accordingly, in a 2.5 wt. % dispersion, the activated pectin-containing apple fiber has a yield strength I (rotation) of more than 5.0 Pa, advantageously of more than 6.0 Pa, and particularly advantageously of more than 7.0 Pa.

According to a further embodiment, the activated pectin-containing apple fiber has, in a 2.5 wt. % suspension, a yield strength II (cross-over) of more than 0.1 Pa, advantageously more than 0.5 Pa and particularly advantageously more than 1.0 Pa. In a 2.5 wt. % dispersion, the activated pectin-containing apple fiber has a yield strength I (cross-over) of more than 5.0 Pa, advantageously more than 6.0 Pa and particularly advantageously more than 7.0 Pa.

In one embodiment, the activated pectin-containing apple fiber has, in a 2.5 wt. % suspension, a dynamic Weissenberg index of more than 4.0, advantageously more than 5.0 and particularly advantageously more than 6.0. After shear activation, the activated pectin-containing apple fiber correspondingly has, in a 2.5 wt. % dispersion, a dynamic Weissenberg index of more than 6.5, advantageously more than 7.5 and particularly advantageously of more than 8.5.

According to an advantageous embodiment, the activated pectin-containing apple fiber has a strength of more than 50 g, preferably more than 75 g and particularly preferably more than 100 g. For this purpose, the pectin-containing apple fiber is suspended in water as a 6 wt. % solution.

Preferably, the activated pectin-containing apple fiber has a viscosity of more than 100 mPas, preferably more than 200 mPas and particularly preferably more than 350 mPas, wherein the activated apple fiber is dispersed in water as a 2.5 wt. % solution and the viscosity is measured at a shear rate of 50 s⁻¹ at 20° C.

For determining viscosity, the apple fiber is dispersed in demineralized water by the method disclosed in the Examples as a 2.5 wt. % solution and the viscosity is determined at 20° C. and four shear sections (first and third section=constant profile; second and fourth section=linear ramp; measurement in each case at a shear rate of 50 s⁻¹) (rheometer; Physica MCR 101, measuring bob CC5 (corresponds to Z3 DIN), Anton Paar, Graz, Austria). An activated pectin-containing apple fiber with this high viscosity has the advantage that smaller amounts of fiber are required for thickening the final product. In addition, the fiber thus produces a creamy texture.

Advantageously, the activated pectin-containing apple fiber has a water-binding capacity of more than 20 g/g, preferably more than 22 g/g, particularly preferably more than 24 g/g, and especially preferably more than 27.0 g/g. Such an advantageously high water-binding capacity leads to a high viscosity and consequently also to lower fiber consumption with a creamy texture.

According to one embodiment, the activated pectin-containing apple fiber has a moisture content of less than 15%, preferably less than 8% and particularly preferably less than 6%.

It is also preferred for the activated pectin-containing apple fiber in 1.0 wt. % aqueous suspension to have a pH of from 3.5 to 5.0 and preferably from 4.0 to 4.6.

Advantageously, the activated pectin-containing apple fiber has a particle size in which at least 90% of the particles are smaller than 400 μm, preferably smaller than 350 μm and in particular smaller than 300 μm.

According to an advantageous embodiment, the activated pectin-containing apple fiber has a lightness value of L*>60, preferably of L*>61 and particularly preferably of L*>62.

Advantageously, the activated pectin-containing apple fiber has a dietary fiber content of 80 to 95%.

The activated pectin-containing apple fiber used according to the invention is preferably available in powder form. This has the advantage of providing a formulation with low weight and high storage stability, which can also be used in a simple manner in terms of process technology. This formulation is only made possible by the activated pectin-containing apple fiber used in accordance with the invention, which, unlike modified starches, does not tend to form lumps when stirred into liquids.

Due to the acidic extraction step, the pectin content of the apple fiber has been greatly reduced, so that the activated pectin-containing apple fiber has less than 10%, preferably less than 8% and particularly preferably less than 6% of water-soluble pectin. This residual pectin is high-esterified pectin. According to the invention, a high-esterified pectin is understood to be a pectin which has a degree of esterification of at least 50%. The degree of esterification describes the percentage of carboxyl groups in the galacturonic acid units of the pectin which are present in esterified form, e.g. as methyl esters. The degree of esterification can be determined using the method according to JECFA (Monograph 19-2016, Joint FAO/WHO Expert Committee on Food Additives).

Preparation of the Activated Pectin-Containing Apple Fiber

The activated pectin-containing apple fiber is obtainable by a method comprising the following steps:
(a) providing a raw material containing cell wall material of an apple;
(b) disintegrating the raw material by incubating an aqueous suspension of the raw material at an acidic pH;
(c) separating coarse particles in one or more steps from the disintegrated material from step (b) in aqueous suspension;
(d) separating the material free of coarse particles, which was obtained in step (c), from the aqueous suspension;
(e) washing the material separated in step (d) with an aqueous solution;
(f) separating the washed material from step (e) from the aqueous solution;
(g) washing the separated material from step (f) at least twice with an organic solvent and then separating the washed material from the organic solvent each time;
(h) optionally additionally removing the organic solvent by contacting the washed material from step (g) with water vapor;
(i) drying the material from step (g) or (h), comprising vacuum drying to obtain the activated pectin-containing apple fiber.

As raw material, apples, and preferably processing residues of apples, can be used. For the method according to the invention, correspondingly apple peel, apple core, kernels, pulp or a combination thereof can be employed. Preferably, apple pomace is used as raw material, i.e. the press residues of apples which typically contain, in addition to the peels, also the abovementioned components.

As apples, all cultivated apples known to the person skilled in the art can be used.

Acidic disintegration in step (b) of the method serves to remove pectin by converting the protopectin into soluble pectin and simultaneously activating the fiber by enlarging the internal surface area. Furthermore, the pulping process thermally comminutes the raw material. Acidic incubation in an aqueous environment under the action of heat causes it to disintegrate into apple fibers. Thermal comminution is thus achieved, and a mechanical comminution step is not necessary as part of the production process. This is a decisive advantage over conventional fiber production processes, which, in contrast, require a shearing step (such as by (high) pressure homogenization) to obtain a fiber with adequate rheological properties.

By acidic disintegration as a process step in the production method, the fiber structure can be disintegrated and the structure can be maintained accordingly through subsequent alcoholic washing steps with gentle drying.

The raw material is available as an aqueous suspension during the disintegration step (b). A suspension in the sense of the invention is a heterogeneous mixture of substances consisting of a liquid and solids (raw material particles) finely distributed therein. Since the suspension tends to sedimentation and phase separation, the particles are suitably kept in suspension by shaking or stirring. Thus, there is no dispersion in which the particles are broken up by mechanical action (shear) so that they are finely dispersed.

To obtain an acidic pH in step (b), the person skilled in the art can make use of any acid or acidic buffer solution known to him. For example, an organic acid such as citric acid may be used.

Alternatively, or in combination, a mineral acid can also be used. Examples include sulfuric acid, hydrochloric acid, nitric acid or sulfuric acid. Preferably, sulfuric acid is used.

In the acidic disintegrating in step (b) of the method, the pH of the suspension is between pH=0.5 and pH=4.0, preferably between pH=1.0 and pH=3.5, and particularly preferably between pH=1.5 and pH=3.0.

According to the invention, the liquid for preparing the aqueous suspension comprises more than 50 vol %, preferably more than 60, 70, 80 or even 90 vol % of water. In a preferred embodiment, the liquid contains no organic solvent and in particular no alcohol. Thus, water-based acidic extraction takes place.

In one embodiment, no enzymatic treatment of the raw material by addition of an enzyme, in particular no amylase treatment, takes place in the production process and in particular in the acidic disintegration in step (b).

The incubation in the acidic disintegration in step (b) is carried out at a temperature between 60° C. and 95° C., preferably between 70° C. and 90° C. and particularly preferably between 75° C. and 85° C.

The incubation in step (b) is carried out for a period of time between 60 min and 10 hours and preferably between 2 hours and 6 hours.

The aqueous suspension suitably has a dry weight of between 0.5 wt. % and 5 wt. %, preferably between 1 wt. % and 4 wt. %, and particularly preferably between 1.5 wt. % and 3 wt. % during the acidic disintegration in step (b).

The aqueous suspension is stirred or shaken during the disintegration in step (b). This is preferably done in a continuous manner to keep the particles in suspension.

In step (c) of the method, the disintegrated material is separated from coarse particles. This separation is carried out as a single-stage or multi-stage separation.

During one- or multi-stage separation, it is advantageous to perform separation of particles with a particle size of more than 1000 μm, more preferably more than 500 μm. This removes both coarse particulate impurities and insufficiently disintegrated material from the raw material.

Advantageously, the disintegrated material is subjected to a multi-stage separation in step (c). Here, it is preferred for the separation of the coarse particles to be carried out stepwise to separate increasingly finer particles. This means, for example, that in a two-stage separation, both stages perform a separation of larger particles, with finer particles being separated in the second stage compared to the first stage. Thus, the material becomes more and more finely particulate with each separation step.

Particularly advantageous according to step (c) is here a two-stage separation with a separation of particles with a size of more than 1000 μm in the first stage and a separation of particles with a size of more than 500 μm in the second stage. Separation in these two stages is advantageously performed by means of a revolving screen, a strainer or a different device for wet screening.

After acidic disintegration in step (b), removal of coarse particles in step (c) and separation of the disintegrated material from the aqueous suspension in step (d), the separated material is washed with an aqueous solution in step (e). Through this step, remaining water-soluble substances, such as sugar, can be removed. Especially the removal of sugar by means of this step helps to make the apple fiber less adhesive and thus easier to process and use.

In the context of the invention, the “aqueous solution” is understood to be the aqueous liquid used for washing. The mixture of this aqueous solution and the disintegrated material is referred to as the “wash mixture”.

Advantageously, the washing according to step (e) is carried out with water as the aqueous solution. Particularly advantageous here is the use of deionized water.

In one embodiment, the aqueous solution comprises more than 50 vol %, preferably more than 60, 70, 80 or even 90 vol % of water. In a preferred embodiment, the aqueous solution contains no organic solvent and in particular no alcohol. Thus, a water-based wash takes place and no water-alcohol exchange as in the case of fiber washing with a mixture of alcohol and water, this mixture having more than 50 vol % alcohol and typically an alcohol content of more than 70 vol %.

Alternatively, a salt solution with an ionic strength of I<0.2 mol/l can be used as the aqueous solution.

The washing according to step (e) is advantageously carried out at a temperature between 30° C. and 90° C., preferably between 40° C. and 80° C. and particularly preferably between 50° C. and 70° C.

The period of contacting with the aqueous solution in step (e) takes place over a period of between 10 min and 2 hours, preferably between 30 min and one hour.

During washing according to step (e), the dry matter in the wash mixture is between 0.1 wt. % and 5 wt. %, preferably between 0.5 wt. % and 3 wt. %, and particularly preferably from between 1 wt. % and 2 wt. %.

More advantageously, washing according to step (e) is carried out with mechanical agitation of the wash mixture. This is conveniently done by stirring or shaking the wash mixture.

Optionally, a separation of particles with a size of more than 500 μm, preferably more than 400 μm and most preferably more than 350 μm, can also take place during washing in step (e). Separation is advantageously performed by means of a strainer or a belt press. This helps to remove both coarse particulate matter and insufficiently disintegrated matter from the raw material.

After washing with the aqueous solution, the washed material is separated from the aqueous solution according to step (f). This separation is advantageously carried out with a decanter or a separator.

In step (g), a further washing step is then carried out, but this time with an organic solvent. This involves washing at least twice with an organic solvent.

The organic solvent can also be used as a mixture of the organic solvent and water, in which case this mixture has more than 50% by volume of organic solvent and preferably more than 70% by volume of organic solvent.

The organic solvent is advantageously an alcohol which may be selected from the group consisting of methanol, ethanol and isopropanol.

The washing step in step (g) is carried out at a temperature between 40° C. and 75° C., preferably between 50° C. and 70° C., and particularly preferably between 60° C. and 65° C.

The period of contacting with the organic solvent in step (g) is carried out over a period of time between 60 min and 10 h and preferably between 2 h and 8 h.

Each washing step with the organic solvent comprises contacting the material with the organic solvent for a certain period of time followed by separation of the material from the organic solvent. A decanter or a press is preferably used for this separation.

During washing with the organic solvent, the dry matter in the washing solution is between 0.5 wt. % and 15 wt. %, preferably between 1.0 wt. % and 10 wt. %, and particularly preferably between 1.5 wt. % and 5.0 wt. %

Washing with the organic solvent in step (g) is preferably carried out under mechanical agitation of the wash mixture. Preferably, the washing is carried out in a vessel with an agitator.

During washing with the organic solvent in step (g), advantageously, a device for homogenization of the suspension is used. This device is preferably a toothed-ring disperser.

According to an advantageous embodiment, washing with the organic solvent in step (g) is carried out in a countercurrent process.

According to one embodiment, washing with the organic solvent in step (g) involves partial neutralization by addition of Na or K salts, NaOH or KOH.

During washing with the organic solvent in step (g), an additional decoloring of the material can also be carried out. This decoloring can be performed by adding one or more oxidizing agents. These can be, for example, chlorine dioxide and hydrogen peroxide, which can be used alone or in combination.

According to an advantageous embodiment, during the at least two-fold washing with an organic solvent, the final concentration of the organic solvent in the solution increases with each washing step. This incrementally increasing amount of organic solvent reduces the amount of water in the fiber material in a controlled manner, so that the rheological properties of the fibers are maintained during the subsequent solvent removal and drying steps and no collapse of the activated fiber structure occurs.

Preferably, the final concentration of organic solvent is between 60 and 70% by volume in the first washing step, between 70 and 85% by volume in the second washing step, and between 80 and 90% by volume in an optional third washing step.

According to the optional step (h), the proportion of the solvent can additionally be reduced by bringing the material in contact with water vapor. This is preferably done with a stripper, in which the material is brought in contact with water vapor as a stripping gas in countercurrent.

In step (i), drying of the washed material from step (g) or of the stripped material from step (h) takes place, with drying comprising vacuum drying and preferably consisting of vacuum drying. In vacuum drying, the washed material is subjected, as dry material, to a negative pressure, which lowers the boiling point and thus causes an evaporation of the water even at lower temperatures. The heat of evaporation continuously removed from the dry material is suitably restored from outside until constant temperature is reached. Vacuum drying has the effect of lowering equilibrium vapor pressure, which promotes capillary transport. This has proved to be advantageous especially for the present apple fiber material since it helps to maintain the activated open fiber structures and therefore the resulting rheological properties. Preferably, vacuum drying takes place at an absolute negative pressure of less than 400 mbar, preferably less than 300 mbar, further preferably less than 250 mbar and particularly preferably less than 200 mbar.

The drying under vacuum in step (i) is suitably carried out at a shell temperature of between 40° C. and 100° C., preferably of between 50° C. and 90° C. and particularly preferably of between 60° C. and 80° C. Following drying, the product is expediently cooled to room temperature.

According to an advantageous embodiment, after drying in step (i), the method additionally comprises a comminution, grinding or screening step. This step is advantageously designed such that as a result 90% of the particles have a particle size of less than 400 μm, preferably a particle size of less than 350 μm and in particular a particle size of less than 300 μm. At this particle size, the fiber is readily dispersible and has optimum swelling properties.

The activated apple fiber and a method for the production thereof are disclosed in application DE 10 2020 115 501.8.

Low-Esterified Soluble Pectin

According to a preferred embodiment, the low-esterified soluble pectin has a degree of esterification of 15 to 50%, preferably 25 to 48%, particularly preferably 30 to 46% and especially preferably 36 to 42%, with respect to the galacturonic acid units of the pectin. For instance, the degree of esterification of the low-esterified soluble pectin may preferably be 26%, 27%, 28%, 29%, 30%, 31%, 32%, 33%, 34%, 35%, 36%, 37%, 38%, 39%, 40%, 41%, 42%, 43%, 44%, 45%, 46%, 47% or 48%. Low-esterified soluble pectins with such a degree of esterification are particularly suited for forming a stable and homogeneous unfrozen serum phase.

In particular, the low-esterified soluble pectin, in case it is a citrus pectin, has a degree of esterification of 36 to 40% with respect to the galacturonic acid units of the pectin.

In particular, the low-esterified soluble pectin, in case it is an apple pectin, has a degree of esterification of 38 to 42% with respect to the galacturonic acid units of the pectin.

The low-esterified soluble pectin preferably has a calcium sensitivity of 200 to 3000 HPE, preferably 300 to 2500 HPE, particularly preferably 400 to 2000 HPE, further preferably 500 to 1500 HPE and most preferably 500 to 1000 HPE, HPE being an abbreviation of “Herbstreith-Pektinometer-Einheiten” (“Herbstreith pectinometer units”). For instance, the calcium sensitivity of the low-esterified soluble pectin can amount to 400 HPE, 500 HPE, 600 HPE, 700 HPE, 800 HPE, 900 HPE, 1000 HPE, 1100 HPE, 1200 HPE, 1300 HPE or 1400 HPE. If the low-esterified soluble pectin has a calcium sensitivity as high as this, a particularly good texture of the ice cream can be achieved. The test method is described in detail in the examples of embodiment.

Preferably, the low-esterified soluble pectin, in case it is a citrus pectin, has a calcium sensitivity of 200 to 3000 HPE, preferably 300 to 2500 HPE, particularly preferably 400 to 2000 HPE, further preferably 500 to 1500 HPE and most preferably 600 to 1000 HPE, HPE being an abbreviation of “Herbstreith-Pektinometer-Einheiten” (“Herbstreith pectinometer units”). For instance, the calcium sensitivity of the low-esterified soluble citrus pectin can amount to 400 HPE, 500 HPE, 600 HPE, 700 HPE, 800 HPE, 900 HPE, 1000 HPE, 1100 HPE, 1200 HPE, 1300 HPE or 1400 HPE. At such a calcium sensitivity, the low-esterified soluble citrus pectin has particularly good swelling properties and ensures particularly good melt-off behavior of the ice cream.

Preferably, the low-esterified soluble pectin, in case it is an apple pectin, has a calcium sensitivity of 200 to 2500 HPE, preferably 300 to 2000 HPE, particularly preferably 400 to 1500 HPE and most preferably 500 to 1000 HPE, with HPE being an abbreviation of “Herbstreith-Pektinometer-Einheiten” (“Herbstreith pectinometer units”). For example, the calcium sensitivity of the low-esterified soluble apple pectin can amount to 400 HPE, 500 HPE, 600 HPE, 700 HPE, 800 HPE, 900 HPE, 1000 HPE, 1100 HPE, 1200 HPE, 1300 HPE or 1400 HPE. At such a calcium sensitivity, the low-esterified soluble apple pectin has particularly good swelling properties and ensures particularly good melt-off behavior of the ice cream.

Low-Esterified Amidated Soluble Pectin

In a preferred embodiment, the low-esterified soluble pectin is a low-esterified amidated soluble pectin. According to a preferred embodiment, the low-esterified amidated soluble pectin has a degree of esterification of from 25 to 50%, preferably from 29 to 45%, particularly preferably from 34 to 40%, and particularly preferably from 36% to 37.5%, based on the galacturonic acid units of the pectin. For example, the degree of esterification of the low-esterified amidated soluble pectin may preferably be 29%, 30%, 31%, 32%, 33%, 34%, 35%, 36%, 37%, 38%, 39%, 40%, 41%, 42%, 43% or 44%. Low-esterified amidated soluble pectins having such a degree of esterification are particularly suitable for forming a highly viscous homogeneous unfrozen serum phase.

Preferably, in the case where the amidated soluble pectin is a citrus pectin, the low-esterified amidated soluble pectin has a degree of esterification of from 25 to 50%, preferably from 30 to 45%, more preferably from 35 to 40%, and particularly preferably of 37.5%, based on the galacturonic acid units of the pectin. For example, the degree of esterification of the low-esterified amidated soluble citrus pectin may preferably be 30%, 31%, 32%, 33%, 34%, 35%, 36%, 37%, 38%, 39%, 40%, 41%, 42%, 43% or 44%.

Preferably, in the case where the amidated soluble pectin is an apple pectin, the low-esterified amidated soluble pectin has a degree of esterification of from 25 to 50%, preferably from 29 to 44%, more preferably from 34 to 39%, and especially preferably of 36%, based on the galacturonic acid units of the pectin. For example, the degree of esterification of the low-esterified amidated soluble citrus pectin may preferably be 30%, 31%, 32%, 33%, 34%, 35%, 36%, 37%, 38%, 39%, 40%, 41%, 42% or 43%.

Preferably, the low-esterified amidated soluble pectin has an amidation degree of from 6 to 18%, preferably from 8 to 17%, more preferably from 10 to 16%, and most preferably from 11 to 15%, based on the galacturonic acid units of the pectin. At such a degree of amidation, the low-esterified amidated soluble pectin exhibits particularly good swelling properties and ensures particularly good melt-off behavior of the ice cream.

Preferably, the low-esterified amidated soluble pectin has a degree of amidation of 6 to 16%, preferably of 8 to 14%, particularly preferably of 10 to 12% and most preferably of 11%, based on the galacturonic acid units of the pectin, in the case where it is a citrus pectin. At such a degree of amidation, the low-esterified amidated soluble citrus pectin exhibits particularly good swelling properties and ensures particularly good melt-off behavior of the ice cream.

Preferably, the low-esterified amidated soluble pectin has a degree of amidation of 8 to 18%, preferably of 10 to 17%, particularly preferably of 12 to 16% and most preferably of 13% to 15%, based on the galacturonic acid units of the pectin, in the case where it is an apple pectin. At such a degree of amidation, the low-esterified amidated soluble apple pectin exhibits particularly good swelling properties and ensures particularly good melt-off behavior of the ice cream.

The low-esterified amidated soluble pectin preferably exhibits a calcium reactivity of 500 to 3000 HPE, preferably 700 to 2500 HPE, particularly preferably 1000 to 2000 HPE, most preferably 1400 to 1700 HPE, where HPE stands for Herbstreith pectinometer units. If the low-esterified amidated soluble pectin exhibits such a high calcium reactivity, a particularly good texture of the ice cream can be achieved. A detailed specification of the test procedure is provided in the examples of embodiment.

High-Esterified Soluble Pectin

The high-esterified soluble pectin preferably has a degree of esterification of from 60 to 80%, preferably from 64 to 76%, more preferably from 66 to 74%, and most preferably from 68 to 70%; based on the galacturonic acid units of the pectin. For example, the degree of esterification of the high-esterified soluble pectin may preferably be 65%, 66%, 67%, 68%, 69%, 70%, 71%, 72%, 73% or 74%. At such a degree of esterification of the high-esterified soluble pectin, the high-esterified soluble pectin exhibits particularly good compatibility with the other components and a high gelling rate.

Advantageously, the high-esterified soluble pectin exhibits a gelling power of 140 to 280° USA-Sag, preferably of 160 to 260° USA-Sag, and particularly preferably of 170 to 250° USA-Sag. The high gelling power of the high-esterified soluble pectin has a positive effect on the texture of the ice cream and its syneresis behavior. The gelling power can be determined by means of the method 5-54 of the IFT Committee on Pectin Standardisation, Food Technology, 1959, 13: 496-500.

Advantageously, the high-esterified soluble pectin, in case it is a high-esterified soluble citrus pectin, has a gelling power of 200 to 280° USA-Sag, preferably of 220 to 260° USA-Sag, particularly preferably of 230 to 250° USA-Sag and especially preferably of 240° USA-Sag. The high gelling power of the high-esterified pectin has a positive effect on the texture of the preparation and its syneresis behavior.

Advantageously, the high-esterified soluble pectin, in case it is a high-esterified soluble apple pectin, has a gelling power of 140 to 220° USA-Sag, preferably of 160 to 200° USA-Sag and particularly preferably of 170 to 180° USA-Sag. The high gelling power of the high-esterified pectin has a positive effect on the texture of the preparation and its syneresis behavior.

Other Characteristics of the Composition

Furthermore, it is preferred for the composition according to the invention to have a pH value of 3 to 5 and preferably of 3.4 to 4.5 in a 1.0 wt. % aqueous suspension. At this pH value, the soluble pectin is chemically most stable.

The composition according to the invention is preferably available in powder form. The advantage is that in this manner, there is a formulation with low weight and high storage stability which is easy to use also in terms of process technology. Such a formulation is made possible only by the plant fiber according to the invention which, other than modified starches, does not tend to form lumps when stirred into liquids.

In addition to the components plant fiber, low-esterified, preferably amidated, soluble pectin, high-esterified soluble pectin and, optionally, sugar, the composition according to the invention can also comprise other components. In particular, it can additionally contain maltodextrin, soluble dietary fibers without viscosity build-up, such as inulin or stable maltodextrin, and sugar alcohols, for example, erythritol, sorbitol, Palatinit or mannitol. The abovementioned components can contribute to avoid the formation of lumps.

Use of the Composition

The invention further relates to use of the composition according to the invention as a semi-finished product in the food industry. It has been shown that the composition is perfectly suited for this purpose since it provides a pleasant texture and high dimensional stability even if used in frozen foods for immediate consumption. However, it is basically suitable to be used in many very different types of foods, not only in frozen foodstuff. It is particularly well-suited as a semi-finished product in desserts which are stored frozen and consumed unfrozen; in cream desserts, such as panna cotta, roasted cream desserts, cream desserts based on milk alternatives, in particular coconut milk, oat milk and soy milk; as well as in dessert sauces, for example caramel sauce, chocolate sauce or fruit sauce.

According to a preferred embodiment of the usage according to the invention, the composition according to the invention is used as a semi-finished product for the production of ice cream, low-calorie ice cream, plant-based ice cream or ice cream with insect protein. The composition has proved to be a particularly well-suited semi-finished product for these applications.

What has been said with regard to the composition according to the invention and with regard to its components also applies accordingly to usage according to the invention of the composition according to the invention.

Preferably, the composition according to the invention is used as a semi-finished product. This means that the composition containing plant fiber, low-esterified soluble pectin and in addition high-esterified soluble pectin is preferably used to manufacture frozen foods as a mixture of these (and optionally other) components.

In an alternative embodiment, the three main components of the composition according to the invention can be employed separately, which means that all three components, namely pectin-containing plant fiber, low-esterified soluble pectin and high-esterified soluble pectin, are added in succession or a mixture of two components is added at a different time than the third component. Furthermore, the components can be stored individually or as a mixture of two components in different ingredients of the frozen food to be produced, so that the composition according to the invention is only formed when these ingredients are mixed.

Ice Cream

The invention further relates to an ice cream containing the composition according to the invention, the ice cream comprising one of more of the following ingredients:
a. an aqueous solution which is preferably milk and/or a milk product, the water moiety in the ice cream being 20 to 80 wt. %, preferably 30 to 70 wt. %, particularly preferably 40 to 65 wt. % and especially preferably 50 to 65 wt. %, referred to the total weight of the ice cream;
b. a source of fat of plant or animal origin or a combination thereof, the fat content in the ice cream being preferably 0.5 to 30 wt. %, particularly preferably 0.5 to 20 wt. %, further preferably 0.5 to 15 wt. % and especially preferably 0.5 to 12 wt. %, referred to the total weight of the ice cream;
c. a source of protein of plant or animal origin or a combination thereof, the protein content in the ice cream being preferably 0.5 to 30 wt. %, particularly preferably 1 to 20 wt. %, further preferably 1 to 10 wt. %, especially preferably 2 to 5 wt. %, referred to the total weight of the ice cream;
d. sugar and/or a sugar substitute, the sugar content in the ice cream being preferably 5 to 50 wt. %, particularly preferably 8 to 40 wt. %, further preferably 10 to 30 wt. %, especially preferably 12 to 25 wt. %, referred to the total weight of the ice cream;
   the ice cream containing the composition according to the invention in a moiety of 0.2 to 5 wt. %, preferably 0.2 to 3 wt. %, particularly preferably 0.5 to 2 wt. % and especially preferably 0.5 to 1.0 wt. %, referred to the total weight of the ice cream. The ice cream according to the invention has a pleasing texture and an excellent melt-off behavior. If, in contrast, the ice cream contains less than 0.2 wt. % of the composition according to the invention, the melt-off behavior and the dimensional stability of the ice cream are significantly impaired. If the ice cream contains more than 5 wt. % of the composition according to the invention, the production of the ice cream is more difficult.

According to a preferred embodiment, the ice cream according to the invention comprises at least two of the ingredients a. through d., further preferably at least three of the ingredients a. through d. and particularly preferably all four ingredients a. through d. If the ice cream according to the invention comprises all four of the ingredients a. through d. in the indicated amounts, the ice cream has a particularly good texture and an especially pleasant flavor.

The ice cream according to the invention is characterized by the particularly good texture, the high dimensional stability and the excellent melt-off behavior.

According to a preferred embodiment of the ice cream according to the invention, the ice cream has an ice crystal growth rate of 0.001 to 10 μm/min, preferably 0.01 to 8 μm/min, particularly preferably 0.03 to 6 μm/min, especially preferably 0.04 to 2 μm/min, the temperature for determining ice crystal growth being −12° C.

Preferably, the ice cream according to the invention exhibits a reduction in the number of ice crystals of 1 to 99%, preferably 10 to 90%, particularly preferably 20 to 90%, especially preferably 40 to 80%, within a time period of 300 min at a temperature of −12° C.

According to a preferred embodiment, the ice cream according to the invention has a melt-off rate of 0 g/min to 100 g/min, preferably 0 g/min to 80 g/min, particularly preferably 0 g/min to 50 g/min, especially preferably 0 g/min to 10 g/min; for the melt-off test 100 ml of ice cream being placed on a perforated grid with a hole diameter of approximately 10 mm and a space of approximately 2 mm between the holes for a time of up to 80 min, and the ambient temperature during the melt-off test being 23° C.

According to a preferred embodiment, the ice cream has a freezing point of −0.1° C. to −15° C., preferably −0.1° C. to −12° C., particularly preferably −2° C. to −10° C. and especially preferably −2° C. to −5° C. At such a freezing point, it is guaranteed that frozen water in the ice cream is not separated from the other components during cold storage.

The ice cream according to the invention is characterized by a good texture and high dimensional stability. Preferably, the ice cream has a premix viscosity of 50 to 1200 mPas, preferably 100 to 950 mPas and particularly preferably 200 to 500 mPas, the viscosity of the premix being measured with a shear rate of 50 s⁻¹ at 4° C.

According to a preferred embodiment, the ice cream has an incorporation of air (overrun) of 10% to 170%, preferably 40% to 140%, particularly preferably 50% to 120%, especially preferably 90% to 110%, referred to the total volume of the ice cream. An incorporation of air of 100% means that half the total volume of the ice cream consists of incorporated air and the ice cream mass constitutes the other half of the total volume. Such an incorporation of air results in a particularly creamy ice cream.

According to another embodiment of the invention, the ice cream has a portion of destabilized fat of 1 to 50 wt. %, preferably 5 to 35 wt. %, particularly preferably 8 to 25 wt. % and especially preferably 10 to 20 wt. %, referred to the overall fat content of the ice cream, the portion of destabilized fat being measured at a single wavelength of 540 nm. A detailed description of the test method for determining the portion of destabilized fat is included in the examples of embodiments.

The ice cream according to the invention is characterized by a homogeneous and pleasant texture. According to a preferred embodiment, the ice cream has an average ice crystal diameter of 0.01 to 200 μm, preferably 0.1 to 150 μm, particularly preferably 0.1 to 100 μm, especially preferably 1 to 60 μm. The ice crystal diameter can be measured by means of the camera software Visicam Analyzer 5.0 under a light microscope. Here, approximately 150 ice crystals are measured per micrograph and the average ice crystal size in μm is determined, corresponding to the average ice crystal diameter.

Since the ice cream according to the invention contains, as a stabilizer system, the composition according to the invention, which has a low caloric content, it is also possible to obtain a low-calorie ice cream. According to a preferred embodiment of the invention, the ice cream has a caloric value of 5 kcal to 500 kcal/100 g, preferably 10 kcal to 400 kcal/100 g, particularly preferably 40 kcal to 250 kcal/100 g, especially preferably 50 kcal to 150 kcal/100 g.

According to a particularly preferred embodiment, the ice cream is a plant-based ice cream. In this manner, the ice cream according to the invention can constitute a vegan alternative to other ice cream products. Preferably, the plant-based ice cream according to the invention comprises as ingredients water, a plant-based source of fat, such as coconut butter, palm butter, cocoa butter, nuts or cereals, a plant-based protein source, for example pea, hemp or soy, sugar and/or a sugar substitute. With this embodiment of the ice cream according to the invention, a plant-based ice cream with excellent melt-off behavior and a pleasing taste can be obtained.

According to another advantageous embodiment, the protein source in the ice cream comprises a protein source obtained from insects. According to a further advantageous embodiment, the protein source in the ice cream is a protein source obtained from insects. In recent years, insects have proved to be an inexpensive, healthy and ecologically sustainable source of protein with increasing importance.

The ice cream according to the invention can also contain further ingredients. Among these, there are, for instance, taste-bearing substances such as cocoa powder, plant extracts such as vanilla, peppermint, tonka bean or licorice; fruit puree, for example strawberry, blackcurrant or cherry; vegetable puree, such as avocado, tomato or carrot; fruit powder; flavorings, such as peppermint, vanilla; soluble dietary fibers, for instance inulin or resistant maltodextrin; yoghurt powder; cream cheese; nut pastes, such as pistachio, walnut or hazelnut; milk substitutes, for instance based on oat, coconut or soy; spirits; wine or wine products. What has been said concerning the composition according to the invention and the ingredients contained therein applies accordingly to the ice cream according to the invention.

Method of Manufacturing Ice Cream

The invention further relates to a method of manufacturing the ice cream according to the invention.

The method according to the invention for manufacturing the ice cream according to the invention comprises at least the following steps:
a. providing the composition according to the invention;
b. optionally providing an aqueous solution which is preferably milk and/or a milk product;
c. optionally providing other components, in particular a source of fat which is of plant or animal origin or a combination thereof, a protein source which is of plant or animal origin or a combination thereof, and/or a sugar and/or a sugar substitute;
d. combining, in particular mixing, the components provided in steps a. through c. in order to obtain a mixture;
e. heating the mixture obtained in step d. to a temperature of at least 60° C., in particular at least 80° C.;
f. homogenizing the mixture heated in step e., in particular by pressure homogenization;
g. cooling the mixture homogenized in step f. to approximately 4° C.;
h. allowing the mixture to ripen at 4 to 6° C.;
i. freezing out the mixture cooled down in step g. to a temperature of below −4° C.

The method steps a. through i. can be performed in any technically useful order. Preferably, they are carried out in the order indicated. Especially steps a. through c. may be performed in a different order, however.

The combining, in particular mixing, heating, homogenizing and cooling, of the mixture is preferably performed in a pasteurizer. The pasteurizer of the company Carpigiani Pastomaster 60 tronic, having a capacity of 60 l, has proved to be particularly suitable. Preferably, the heating time is from 30 to 40 min and the time of cooling to 4° C. is from 50 to 60 min. When 4° C. have been reached, the ripening time of the premix is preferably 24 hours.

According to a preferred embodiment of the method according to the invention, homogenizing the heated mixture is done by pressure homogenization. A pressure of 10 to 250 bar, in particular 30 to 200 bar, has proved to be preferable for this purpose. As the preferred type of pressure homogenization, two-stage homogenization with different pressures is employed. In a two-stage homogenization process, it is advantageous if the first stage is performed at a higher pressure than the second stage. It is particularly advantageous if the first pressure homogenization is performed at 180 bar and the second one at 60 bar.

Freezing out the ice cream mass is preferably performed in an ice-cream freezer with a continuous mixing flow of 140 l/h, a pressure of 3 bar and an injected incorporation of air of 80 to 120%, with the shock wave frequency not exceeding 700 rpm. For freezing out the ice-cream mass, for instance the ice-cream freezer GIF 600 of the Gram. Equipment company is suitable.

What has been said on the ice cream according to the invention, the ingredients contained therein and the proportions of the components applies accordingly to the method according to the invention for manufacturing the ice cream.

### Definitions

A plant fiber according to the application is a fiber which is isolated from a non-lignified cellular wall of a plant and consists mainly of cellulose. Other components are, among others, hemicellulose and pectin, with the plant fiber according to the application having a content of water-soluble pectin of less than 10 wt. % and preferably less than 6 wt. %. The plant fiber according to the invention advantageously has a content of water-soluble pectin of between 2 wt. % and 8 wt. % and particularly preferably between 2 and 6 wt. %. The content of water-soluble pectin in this plant fiber can be, for instance, 2 wt. %, 3 wt. %, 4 wt. %, 5 wt. %, 6 wt. %, 7 wt. %, 8 wt. %, 9 wt. % or 9.5 wt. %

A fruit fiber according to the invention is a plant fiber according to the above definition which is isolated from a fruit. By “fruit”, the organs as a whole of a plant are understood which originate from a flower, comprising both classic fruits and fruit vegetables.

A “citrus fiber” in the sense of the application is a component consisting mainly of fibers, which is isolated from a non-lignified cellular wall of a citrus fruit and consists mainly of cellulose. In a sense, the term “fiber” is a misnomer since macroscopically, the citrus fibers do not appear as fibers but as a powdery product. Other components of the citrus fiber are, among others, hemicellulose and pectin. The citrus fiber can advantageously be obtained from citrus pulp, citrus peel, citrus vesicle, segment membranes or a combination thereof.

An “apple fiber” in the sense of the application is a component consisting mainly of fibers, which is isolated from a non-lignified cellular wall of an apple and consists mainly of cellulose. In a sense, the term “fiber” is a misnomer since macroscopically, the apple fibers do not appear as fibers but as a powdery product. Other components of the apple fiber are, among others, hemicellulose and pectin.

An activated citrus fiber according to the present application is, in contrast to an activatable (and thus merely partially activated) citrus fiber, defined by the yield strength of the fiber in 2.5% dispersion or by the viscosity. An activated citrus fiber is thus characterized by a yield strength I (rotation) of more than 5.5 Pa, a yield strength I (cross-over) of more than 6.0 Pa or a viscosity of more than 650 mPas.

An activatable citrus fiber according to the present invention is, in contrast to an activated citrus fiber, defined by the yield strength of the fiber in 2.5% dispersion or by the viscosity. An activatable citrus fiber is thus characterized by a yield strength I (rotation) of between 1.0 and 4.0 Pa, a yield strength I (cross-over) of between 1.0 and 4.5 Pa or a viscosity of 150 to 600 mPas.

An activated apple fiber according to the present application is, in contrast to an activatable apple fiber (which is thus merely partially activated), defined by the yield strength of the fiber in 2.5% dispersion or by the viscosity. An activated apple fiber is thus characterized by a yield strength I (rotation) of more than 5.0 Pa or a yield strength I (cross-over) of more than 5.0.

An apple according to the invention is defined as the fruit of a cultivated apple (Malus domestica).

A soluble pectin according to the application is defined as a plant polysaccharide which, as a polyuronide, substantially consists of α-1,4-glycosidically bonded D-galacturonic acid units. The galacturonic acid units are partially esterified with methanol. The degree of esterification describes the percentage degree of carboxyl groups in the galacturonic acid units of the pectin which are present in esterified form, e. g. as methyl esters.

The soluble pectin according to the application is a pectin obtained by extraction from plant tissues. Thus, in contrast to the native plant pectins (protopectins), it is an isolated water-soluble pectin. The soluble pectin according to the invention is a component separate from the plant or fruit fiber, respectively, and therefore does not form part of the same.

The low-esterified pectin according to the application is a pectin with less than 50% esterified galacturonic acid units. This means that the carboxylic acid group is esterified in less than 50% of all galacturonic acid units. Consequently, a pectin polymer with 30 galacturonic acid units is a low-esterified pectin if no more than 14 of the galacturonic acid units are esterified. Normally, the ester group is a methyl ester. Low-esterified pectins preferably have an esterification degree of at least 5% of the galacturonic acid units.

If high-esterified pectins are mentioned here or somewhere else in the application, pectins with at least 50% esterified galacturonic acid units are intended. This means that in at least 50% of all galacturonic acid units, the carboxylic acid group is esterified. Consequently, a pectin polymer with 30 galacturonic acid units is a high-esterified pectin if at least 15 of the galacturonic acid units are esterified. Normally, the ester group is a methyl ester.

The degree of esterification can be determined with the method according to JECFA Monograph 19-2016, Joint FAO/WHO Expert Committee on Food Additives.

If amidated pectins are mentioned here or somewhere else in the application, pectins are intended in which some galacturonic acid units have amide groups instead of the ester groups.

If protopectin is mentioned here or somewhere else in the application, pectins insoluble in water are intended which are present in the cellular walls of plants, in particular in the form of calcium and calcium-magnesium salts.

The degree of esterification of pectins is commonly indicated by VE⁰ and the degree of amidation by A⁰.

Within the framework of the application, a “semi-finished product” is understood to mean a semi-finished article of the food industry which is still going through the manufacturing process and for which further operational steps need to be performed in order to finish it.

The term “low-calorie” according to the invention is intended to mean “reduced in calories” and designates a food product containing at least 30% less calories than conventional products. The calories are mainly saved by the substitution of sugar and fat. The food product may contain less than 200 kcal (838 kJ), preferably less than 150 kcal (628 kJ) and further preferably less than 100 kcal (419 kJ), each referred to 100 g of food product.

A “premix” within the framework of the application is intended to mean the mixed, pasteurized, homogenized and ripened components. “Viscosity of the premix” is therefore intended to mean the viscosity of the mixed, pasteurized, homogenized and ripened components directly before freezing out.

The term “fruit” in the context of the present invention is intended to mean all organs of a plant, taken together, which originate from a flower, comprising both the classic fruits and fruit vegetables. The term “fruit” by itself also comprises mixtures of fruits of two or more different types of plants, such as apple tree and cherry tree, and/or mixtures of two or more different kinds of one fruit, for instance two or more kinds of strawberries, such as Donna®, Daroyal®, Lambada® and Symphony®. The same applies to expressions comprising the term “fruit”, such as “fruit-containing” and “fruit preparation”.

In the context of the present invention, the expression “destabilized fat” is intended to mean the determining method for assessing partial coalescence of the emulsion, which is preferably done by shearing during the process step of freezing out and serves to stabilize the injected air bubbles.

In the following, the invention will be specified in more detail by means of examples of embodiment. The examples do not constitute any limitation to the invention.

### EXAMPLES OF EMBODIMENT

1. Test Methods

1.1 Production of a 2.5 wt. % Fiber Dispersion

Formula:
2.50 g fibers
97.5 g demineralized water (ambient temperature) Sprinkling time: 15 seconds

97.5 g of demineralized water (at ambient temperature) are introduced into a 250 ml beaker. 2.5 g of fibers are slowly and directly sprinkled into the maelstrom with the agitator (Ultra Turrax) running at 8000 rpm (stage 1). The sprinkling time depends on the amount of fibers; it is to last 15 seconds per 2.5 g of sample. Then the dispersion is stirred for exactly 60 seconds at 8000 rpm (stage 1). If the sample is to be used for determining the viscosity or the yield strength I (rotation), the yield strength I (cross-over) or the dynamic Weissenberg index, it is placed in a temperature-controlled water bath at 20° C.

For measuring the viscosity or the yield strength I (rotation), the yield strength I (cross-over) or the dynamic Weissenberg index, the sample is carefully filled into the measurement system of the rheometer after exactly one hour and the respective measurement is started. If the sample precipitates, it is carefully stirred up by means of a spoon directly before filling.

1.2 Production of a 2.5 wt. % Fiber Suspension

Formula:
2.50 g fibers
97.5 g demineralized water (ambient temperature)

97.5 g of demineralized water (at ambient temperature) are introduced into a 250 ml beaker. 2.5 g of fibers are slowly sprinkled in during continuous stirring with a plastic spoon. Then the suspension is stirred until all fibers have been wet with water. If the sample is to be used for determining the viscosity or the yield strength II (rotation), the yield strength II (cross-over) or the dynamic Weissenberg index, it is placed in a temperature-controlled water bath at 20° C.

For measuring the viscosity or the yield strength II (rotation), the yield strength II (cross-over) or the dynamic Weissenberg index, the sample is carefully filled into the measurement system of the rheometer after exactly one hour and the respective measurement is started. If the sample precipitates, it is carefully stirred up by means of a spoon directly before filling.

1.3 Determining of the Yield Strength (Rotational Measurement)

This yield strength is an indicator of the structural strength and is determined by rotational measurement, by increasing the shear stress acting on the sample over time until the sample begins to flow.

Shear stresses below the yield strength merely cause an elastic deformation; it is only shear stresses above the yield strength that will cause the sample to flow. This value is determined by measuring when a defined minimum shear rate γ is exceeded. According to the present method, the yield strength τ₀ [Pa] is exceeded at shear rate γ≥0.1 s⁻¹.

| | |
|---|---|
| measuring device: | Rheometer Physica MCR series |
| | (e.g. MCR 301, MCR 101) |
| measuring system: | Z3 DIN or CC25, respectively |
| measuring vessel: | CC 27 P06 (ribbed measuring vessel) |
| measuring temperature: | 20° C. |

### Measuring Parameters:

1^{st} Section (Resting Period):

| | | |
|---|---|---|
| section settings: | default parameter: | shear stress [Pa] |
| | profile: | constant |

| | | |
|---|---|---|
| value: | 0 | Pa |
| section duration: | 180 | s |
| temperature: | 20° | C. |

2^{nd} Section (Determining of Yield Strength):

| | | |
|---|---|---|
| section settings: | default parameter: | shear stress [Pa] |
| | profile: | ramp log. |

| | | |
|---|---|---|
| initial value: | 0.1 | Pa |
| final value: | 80 | Pa |
| section duration: | 180 | s |
| temperature: | 20° | C. |

3^{rd} Section (Determining of Viscosity)

| | | |
|---|---|---|
| section settings: | default parameter: | shear rate [s⁻¹] |
| | profile: | ramp lin. |

| | | |
|---|---|---|
| initial value: | 0 | s⁻¹ |
| final value: | 120 | s⁻¹ |
| section duration: | 120 | s |
| temperature: | 20° | C. |

Evaluation:

The yield strength τ_{O} (unit [Pa]) is read out in section 2 and is the shear stress (unit [Pa]) at which the shear rate is γ≤0.1 s⁻¹ for the last time.

The yield strength measured with the rotational method is also called “yield strength rotation”.

The yield strength rotation was measured using a fiber suspension (simple stirring in of the fiber with a spoon=corresponds to a non-activated fiber) and is also called “yield strength rotation II” within the context of the invention. The yield strength was also measured using a fiber dispersion (stirred in under the effect of high shear stresses, e. g. with Ultra Turrax=corresponds to an activated fiber) and is also called “yield strength rotation I” within the context of the invention.

1.4 Determining of the Yield Strength (Oscillation Measurement)

Measurement Principle:

This yield strength is also an indicator of the structural strength and is determined in an oscillation test by increasing the amplitude at constant frequency until the sample is destroyed by the ever increasing deflection and then starts to flow.

Below the yield strength, the substance behaves like an elastic solid, that is, the elastic moieties (G′) exceed the viscous moieties (G″) whereas when the yield strength is exceeded, the viscous moieties of the sample increase and the elastic moieties decrease.

By definition, the yield strength is exceeded at the amplitude at which viscous and elastic moieties are equal, G′=G″ (cross-over); the corresponding shear stress is the respective measurement value.

| | |
|---|---|
| measuring device: | Rheometer Physica MCR series |
| | (e.g. MCR 301, MCR 101) |
| measuring system: | Z3 DIN or CC25, respectively |
| measuring vessel: | CC 27 P06 (ribbed measuring vessel) |

Measuring Parameters:

| section settings: | amplitude defaults: | deformation [%] |
|---|---|---|
| | profile: | ramp log. |
| | value: | 0.01-1000% |

| | | |
|---|---|---|
| frequency: | 1.0 | Hz |
| temperature: | 20° | C. |

Evaluation:

With the rheometer software Rheoplus, the shear stress at cross-over is evaluated after the linear-viscoelastic range (G′=G″) has been exceeded.

The yield strength measured with the oscillation method is also called “yield strength cross-over”.

The yield strength cross-over was measured using a fiber suspension (simple stirring in of fiber with a spoon=corresponds to a non-activated fiber) and is also called “yield strength cross-over II” within the framework of the invention. The yield strength was also measured using a fiber dispersion (stirred in under the effect of high shear forces, e. g. with Ultra Turrax=corresponds to an activated fiber) and is also called “yield strength cross-over I” within the framework of the invention.

Measurement Results and their Implications:

By comparing the yield strength of the suspensions of the fibers according to the invention when stirred in with a spoon (corresponding to a non-activated fiber) with the fiber dispersion according to the invention when stirred in under high shear forces, e.g. with Ultra Turrax (corresponding to an activated fiber), a statement on the advantages/necessity of an activation can be made. The measurement results are summarized in the table below. As expected, the yield strength is increased each time by shear activation in the dispersion. For each type of fiber, it is indicated when an activation is necessary.

| | rotation | | cross-over | | |
|---|---|---|---|---|---|
| | τₒ II [Pa] | τₒ I [Pa] | τₒ II [Pa] | τₒ I [Pa] | |
| fiber | suspension | dispersion | suspension | dispersion | activation |
| activated, | 2.3 | 6.9 | 1.8 | 7.2 | not |
| pectin- | | | | | absolutely |
| containing | | | | | necessary |
| citrus fiber | | | | | |
| partially- | 0.8 | 3 | 0.6 | 3.4 | necessary |
| activated, | | | | | |
| activatable | | | | | |
| pectin- | | | | | |
| containing | | | | | |
| citrus fiber | | | | | |
| activated, | 0.1 | 6.7 | 0.2 | 6.5 | necessary |
| pectin- | | | | | |
| containing | | | | | |
| apple fiber | | | | | |

1.5 Determining of Dynamic Weissenberg Index

The dynamic Weissenberg index W′ (Windhab E, Maier T, Lebensmitteltechnik 1990, 44:185f) is a derived quantity which indicates the ratio between the elastic moieties (G′) determined in the linear-viscoelastic range and the viscous moieties (G″):

$${W}^{′} = \frac{{G}^{′} ( ω )}{{G}^{″} ( ω )} = \frac{1}{tan δ}$$

The dynamic Weissenberg index is a variable which correlates particularly well with sensory perception of the consistency of the sample and is quite independent from its absolute strength.

A high value of W′ indicates that the fibers have a largely elastic structure whereas a low value of W′ indicates structures with large viscous moieties. The creamy texture typical of the fibers is achieved when the W′ values are within the range of approximately 6-8; at lower values, the sample is assessed to be aqueous (less thickened).

Material and Methods:

| | |
|---|---|
| measuring device: | Rheometer Physica MCR series |
| | (e.g. MCR 301, MCR 101) |
| measuring system: | Z3 DIN or CC25, respectively |
| measuring vessel: | CC 27 P06 (ribbed measuring vessel) |

Measuring Parameters:

| section settings: | amplitude defaults: | deformation [%] |
|---|---|---|
| | profile: | ramp log. |
| | value: | 0.01-1000% |

| | | |
|---|---|---|
| frequency: | 1.0 | Hz |
| temperature: | 20° | C. |

Evaluation:

The phase shift angle σ is read out in the linear-viscoelastic range. The dynamic Weissenberg index W′ is subsequently calculated with the following formula:

$${W}^{′} = \frac{1}{tan δ}$$

Measurement Results and their Implications:

By comparing the dynamic Weissenberg index W′ of the suspension of a fiber according to the invention when stirred in with a spoon (corresponding to a non-activated fiber) with the fiber dispersion according to the invention when stirred in under high shear forces, e.g. with Ultra Turrax (corresponding to an activated fiber), a statement on the texture and also on the necessity of an activation can be made. The measurement results are summarized in the table below. The results on the dynamic Weissenberg index show that activation of the fiber is necessary to achieve the desired creamy texture, depending on the activation state of the fiber.

| | W′ | W′ | |
|---|---|---|---|
| fiber | suspension | dispersion | texture |
| activated | 8.1 | 7.3 | creamy with and without |
| pectin- | | | activation; |
| containing | | | viscosity/yield strength is |
| citrus fiber | | | regulated via dosage |
| partially- | 7.2 | 7.5 | creamy with and without |
| activated, | | | activation; viscosity/yield |
| activatable | | | strength is regulated via |
| pectin- | | | dosage |
| containing | | | |
| citrus fiber | | | |
| activated | 5 | 9.2 | creamy only after |
| pectin- | | | activation; viscosity/yield |
| containing | | | strength is regulated via |
| apple fiber | | | dosage |

1.6 Determining Water Binding Capacity

The sample is allowed to swell for 24 hours at ambient temperature with excess water. After centrifugation and subsequent decanting of the supernatant, the water binding capacity can be gravimetrically determined in g H₂O/g of sample. The pH value in the suspension must be measured and recorded.

The following parameters are to be observed:

initial weight of sample:

| plant fiber: | 1.0 g (in centrifuge tube) | |
|---|---|---|
| water added: | 60 | ml |
| centrifugation: | 4000 | g |
| duration of centrifugation: | 10 | min |

20 minutes after the beginning of centrifugation (i.e. 10 minutes after the end of centrifugation), the water supernatant is separated from the swollen sample. The sample with the bound water is weighed.

The water binding capacity (Wasserbindungsvermögen, WBV) in g H₂O/g of sample can now be calculated with the following formula:

$$WBV ( g {H}_{2} O / g of sample ) = \frac{sample with bound water ( g ) - 1. g}{1. g}$$

1.7 Determining of Strength

Setup:

150 ml of distilled water are introduced into a beaker. Then 6.0 g of citrus fibers or 9.0 g of apple fibers, respectively, are stirred into the water without the formation of lumps. For swelling, this fiber-water mixture is allowed to stand for 20 min. The suspension is transferred into a vessel (ø 90 mm). Then the strength is measured with the following method:

| Measuring device: | Texture Analyser TA-XT 2 (company Stable | |
|---|---|---|
| | Micro Systems, Godalming, UK) | |
| Parameters: | Test speed: | 1.0 mm/s |
| | path: | 15.0 mm/s |

| | |
|---|---|
| Measurement tools: | P/50 |

The strength corresponds to the force required by the measurement bob to penetrate 10 mm into the suspension. This force is read from the force-time diagram. It should be mentioned that the unit of measured strength in gram (g) is a product of the history of strength measurement.

1.8 Determining of Particle Size

In a screening machine, a set of sieves whose mesh width continuously increases from the bottom sieve to the top one, is arranged on top of one another. The sample is placed on the top sieve, i.e. the sieve with the largest mesh width. The sample particles whose diameter is larger than the mesh width remain on the sieve; the finer particles fall down onto the next lower sieve. The amount of sample remaining on the various sieves is weighed out and indicated as a percentage.

Setup:

The sample is initially weighed to two decimal digits. The sieves are provided with sieving aids and arranged on top of each other with increasing mesh width. The sample is quantitatively transferred onto the top sieve; the sieves are fixed and the sieving process is carried out according to defined parameters. The individual sieves are weighed together with the sample and the sieving aid as well as empty with the sieving aid. If for a product only a limit value in the particle size spectrum is to be assessed (e. g. 90%<250 μm), only one sieve with the respective mesh width is used.

Measurement Default Values:

| amount of sample: | 15 | g |
|---|---|---|
| sieving aids: | 2 per sieve bottom | |
| sieving machine: | AS 200 digit, company Retsch GmbH | |
| sieving motion: | three-dimensional | |
| oscillation height: | 1.5 | mm |
| sieving time: | 15 | min |

The sieve structure has the following mesh widths in μm: 1400, 1180, 1000, 710, 500, 355, 250, followed by the bottom.

The particle size is calculated using the following formula:

$$moiety per sieve in \% = \frac{final weight in g on the sieve \times 100}{initial sample weight in g}$$

1.9 Determining Viscosity

| measuring device: | Physica MCR series (e.g. MCR 301, MCR 101) |
|---|---|
| measurement system: | Z3 DIN or CC25 (note: measurement |
| | systems Z3 DIN and CC25 are identical) |
| number of stages: | 4 |

The temperature of the sample is controlled for at least 15 minutes at 20° C. in a water bath.

Measuring Parameters:

1^{st} Section:

| | | |
|---|---|---|
| section settings: | default variable: | shear rate [s⁻¹] |
| | profile: | constant |

| | | |
|---|---|---|
| value: | 0 | s⁻¹ |
| duration of section: | 60 | s |
| temperature: | 20° | C. |

2^{nd} Section:

| | | |
|---|---|---|
| section settings: | default variable: | shear rate [s⁻¹] |
| | profile: | ramp linear |

| | | |
|---|---|---|
| value: | 0.1-100 | s⁻¹ |
| duration of section: | 120 | s |
| temperature: | 20° | C. |

3^{rd} Section:

| | | |
|---|---|---|
| section settings: | default variable: | shear rate [s⁻¹] |
| | profile: | constant |

| | | |
|---|---|---|
| value: | 100 | s⁻¹ |
| duration of section: | 10 | s |
| temperature: | 20° | C. |

4^{th} Section:

| | | |
|---|---|---|
| section settings: | default variable: | shear rate [s⁻¹] |
| | profile: | ramp linear |

| | | |
|---|---|---|
| value: | 100-0.1 | s⁻¹ |
| duration of section: | 120 | s |

temperature: 20° C.

Evaluation:

The viscosity (unit [mPas]) is read out as follows: 4^{th} section at =50 s⁻¹

1.10 Determining the Degree of Esterification

This method corresponds to the method published by the JECFA (Joint FAO/WHO Expert Committee on Food Additives). Other than with the JECFA method, however, the deashed pectin is not dissolved cold, but heated. For the alcohol, isopropanol instead of ethanol is used.

1.11 Determining Calcium Reactivity

Materials:
230.0 g buffer solution pH 3.2
130 g sugar (sucrose)
5.05 g gelling concentrate
10 ml calcium chloride solution 5% (m/v)

| | |
|---|---|
| initial weight: | 375.0 g |
| final weight: | 335.0 g |
| pH value: | approx. 3.0 |
| dry matter content: | approx. 41% |

production of gelling concentrate:

| | |
|---|---|
| corresponds to 5.05 g: | 3.00 g pectin |
| | 2.05 g buffer mixture |
| | 5.05 gelling concentrate |
| composition buffer mixture: | 1.585 g citric acid anhydrate |
| | (77.3%) |
| | 0.270 g tripotassium citrate |
| | monohydrate, fine (13.2%) |
| | 0.195 g potassium sorbate (9.5%) |
| | 2.05 g buffer mixture |
| production of buffer solution pH 3.2: | 50.0 g citric acid |
| | anhydrate |
| | 2.8 g calcium chloride |
| | dihydrate |
| | 4.8 l demineralized |
| | water |

dissolve citric acid and calcium chloride dihydrate in demineralized water in a 5 l measuring flask;
adjust solution to pH 3.2 with sodium acetate, without water; the sodium acetate is added in solid form; 14 to 15 g of sodium acetate are required;
after temperature regulation in the water bath at 20° C., fill up to the mark.

Measuring Method:

Provide buffer solution in a stainless steel pot.

Mix gelling concentrate with part of the total sugar homogeneously in a mixing flask or glass bowl.

Stir mixture B into the buffer solution, bring to boil and heat with stirring until the pectin is completely dissolved.

Add residual sugar in portions.

Boil out to approx. 340 g, apportion 10 ml calcium chloride solution with stirring and boil out to final weight.

For determining curd firmness, respectively 100+/−1 g of the cooking are quickly weighed into three flow cups with shear insert and the temperature is adjusted in a water bath to 20° C.

After exactly 2 hours, curd firmness is measured with the pectinometer Mark III (company Herbstreith & Fox, Neuenbürg, Germany). The result is the average value of the three single values.

1.11 Determining Calcium Sensitivity

Materials:
320.0 g 0.65 M potassium acetate lactic acid buffer solution (52.50 g potassium acetate, fill in 271.25 g lactic acid with demineralized water to make up 5 l)
60.0 g sugar (sucrose)
3.12 g pectin (corresponding to 0.82% in the final product)
16.0 ml calcium chloride solution 5% (m/v)

| | |
|---|---|
| initial weight: | approx. 399 g |
| final weight: | 380 g |
| filling temperature: | approx. 90° C. |
| pH value: | approx. 3.0 |
| content of dry matter: | approx. 22% |

Measuring Method:
mix pectin and total sugar homogeneously in glass bowl
preheat electric hot plate at least 10 min on highest level
introduce buffer solution into stainless steel pot
pour pectin-sugar mixture into buffer solution with stirring, bring to boil and heat with stirring until pectin is completely dissolved
dose in calcium chloride solution and boil out to final weight
At a temperature of approx. 90° C., 90 g of the cooking are quickly weighed into three Lüers beakers with shear inserts and the temperature is adjusted to 20° C. in a water bath.
Place beakers in a water bath while avoiding impacts.
After exactly 2 h, curd firmness is measured with the pectinometer Mark III (Herbstreith & Fox GmbH & Co. KG pectin factories, Neuenbürg, Germany). The result is the average of the three individual values.

1.12 Determining Gelling Power

The gelling power can be determined using the standard procedure for degree assessment of the pectin in a gel with 65% dry matter. It corresponds to the method 5-54 of the IFT Committee on Pectin Standardisation, Food Technology, 1959, 13: 496-500).

1.13 Determining Dietary Fiber Content

The dietary fiber content is determined by means of the method published by the AOAC (Official Method 991.43: Total, Soluble and Insoluble Dietary Fiber in Foods; Enzymatic-Gravimetric Method, MES-TRIS Buffer, First Action 1991, Final Action 1994.). Preferably, isopropyl alcohol is used instead of ethanol.

1.14 Determining Moisture and Dry Matter

Principle of Operation:

The moisture content of the sample is intended to mean the mass reduction after drying, determined according to defined conditions. The moisture content of the sample is determined by infrared drying with the moisture analyzer Sartorius MA-45 (company Sartorius, Gottingen, Germany).

Setup:

Approximately 2.5 g of the fiber sample are weighed in on the Sartorius moisture analyzer. The settings of the device can be found in the respective factory measuring instructions. The samples are to approximately have ambient temperature for measuring. The moisture content is automatically indicated in percent [% M] by the device. The dry matter is automatically indicated in percent [% S] by the device.

1.15 Determining Color and Lightness

Principle of Operation:

The color and lightness measurements are performed with the Minolta Chromameter CR 300 or CR 400. The spectral properties of a sample are determined using standard color values. The color of a sample is described using the hue, the lightness and the saturation. By means of these three basic properties, the color can be represented three-dimensionally:

The hues are located on the outer shell of the color solid, the lightness is varied on the vertical axis and the degree of saturation changes horizontally. If the L*a*b* measurement system is employed, L* represents lightness whereas a* and b* indicate both the hue and the saturation. a* and b* indicate the positions on two color axes, with a* being assigned to the red-green axis and b* being assigned to the blue-yellow axis. For indicating the color measurement values, the device converts the standard color values into L*a*b* coordinates.

Performance of Measurement:

The sample is sprinkled on a white sheet of paper and flattened with a glass plug. For measurement, the measuring head of the chromameter is directly placed on the sample and the trigger is actuated. A triple measurement is performed of each sample and the average value calculated. The L*, a* and b* values are indicated by the device with two decimals.

1.16 Determining the Proportion of Destabilized Fat

Equipment:
centrifuge: Heraeus Multifuge 3SR+ by Thermo SCIENTIFIC
photometer: DR6000 UV-VIS spectral photometer with RFID technology

Setup:
1^{st} Sampling:
sample 1: premix—shortly before freezing out
sample 2: frozen ice cream mix

Calculation:

$$DSF [ \% ] = \frac{( {a}_{Premix} - {a}_{Eis} )}{{a}_{Premix}} * 100 \%$$

wherein:
DSF: proportion of destabilized fat
a_{Premix}: extinction of premix
a_{Eis}: extinction of ice cream mix
0.2 g of the respective sample are weighed into a 125 ml beaker; the beaker is filled with water (ambient temperature) up to 100 g (dilution: 1:500) and the sample is stirred in with a glass rod. From the dilution, 20 g are filled into a 25 ml glass tube and centrifuged over 5 minutes at a temperature of 30° C. and 160 G. Using a variable Eppendorf pipette, 10 ml precipitate are taken from the centrifuged samples and pipetted into a photometry cuvette. The extinction value of both samples is determined with respect to water as a reference sample at 540 nm. The proportion of destabilized fat can be calculated using the above formula.

1.17 Test Method for Determining Water-Soluble Pectin in Samples Containing Fibers

Principle of Operation:

By means of an aqueous extraction, the pectin contained in fiber-containing samples is converted into the liquid phase. By adding alcohol, the pectin is precipitated from the extract as an alcohol insoluble substance (AIS).

Extraction:

10.0 g of the sample to be analyzed are weighed into a glass dish. 390 g of boiling distilled water are placed in a beaker and the previously weighed sample is stirred in at the highest level for 1 min using Ultra-Turrax.

The sample suspension, cooled to ambient temperature, is divided among four 150 ml centrifuge beakers and centrifuged at 4000×g for 10 min. The supernatant is collected. The sediment from each beaker is resuspended with 50 g of distilled water and centrifuged again at 4000 g for 10 min. The supernatant is collected and the sediment is discarded.

The combined centrifugates are added to approximately 4 l of isopropanol (98%) to precipitate the alcohol-insoluble substance (AIS). After ½ hour, filter through a filter cloth and manually press out the AIS. In the filter cloth, the AIS is then added to approximately 3 l of isopropanol (98%) and loosened by hand using gloves.

The squeezing process is repeated, the AIS is quantitatively removed from the filter cloth, loosened and dried at 60° C. for 1 hour in a drying oven.

The squeezed, dried substance is balanced to 0.1 g for calculation of the alcohol insoluble substance (AIS).

Calculation:

The water-soluble pectin is calculated, based on the fiber-containing sample, using the following formula, with the water-soluble pectin as the alcohol-insoluble substance (AIS):

$$AIS in the sample in wt . \% ( \frac{g}{100 g} ) = \frac{dried AIS [ g ] \times 100}{sample weight in g}$$

2. Comparative Tests

Herbacel® AQ® Plus Citrus-N citrus fiber from Herbafood was used as the plant fiber in the following examples. As the low-esterified, amidated soluble pectin, a citrus pectin Pektin Amid CF 005-B Lot. 1 17 11 802 from Herbstreith & Fox was used. As the high-esterified soluble pectin, a citrus pectin Pektin Classic CJ 201 Lot. 1 17 04 260 from Herbstreith & Fox was used.

2.1 Storage Stability

Storage stability was analyzed by determining the ice crystal growth rate in μm/min at −12° C. and by determining the reduction in the number of ice crystals in % at −12° C.

The composition Z1 according to the invention and the reference composition VZ1 were prepared by simply mixing the components. The proportions of compositions Z1 and formulations R1 and R2 shown below are based on a sugar-free composition (i.e., a composition containing non-standardized pectins).

Composition Z1 according to the invention

| | Proportion in weight percent |
|---|---|
| Ingredient | based on total composition |
| Citrus fiber | 50 |
| (Herbacel ® AQ ® Plus Citrus-N) | |
| Low-esterified, amidated soluble | 27 |
| pectin (citrus pectin; VE⁰ 37.4%, | |
| A⁰ = 11.3%) | |
| High-esterified soluble pectin | 23 |
| (citrus pectin; VE⁰ 68.6%) | |

Reference Composition VZ1

| | Proportion in weight percent |
|---|---|
| Ingredient | based on total composition |
| Locust bean gum | 50 |
| Guar gum | 50 |

Formulations RZ1 and VRZ1 for microscopic analysis of storage stability

| | Formulation RZ1 | |
|---|---|---|
| | according to | Reference |
| | the invention; | formulation VRZ1; |
| Ingredients | data in % by weight | data in % by weight |
| Composition Z1 | 0.2 | — |
| Reference | — | 0.3 |
| composition VZ1 | | |
| Water | 73.1 | 73.1 |
| Glucose-fructose | 11 | 11 |
| syrup (DE 68) | | |
| Sucrose | 15.7 | 15.6 |

The two formulations RZ1 and VRZ1 were premixed with sucrose using Z1 at 0.2 wt. % and VZ1 at 0.3 wt. % according to the indicated proportions. The resulting premix of RZ1 and VRZ1 was then suspended in water along with glucose-fructose syrup.

The freezing point of formulations RZ1 and VRZ1 was adjusted to −3° C. by combining single and double sugars.

Both formulations RZ1 and VRZ1 were heated to a temperature of 85° C., homogenized in a single stage at 240 bar and subsequently cooled down to 4° C. The RZ1 and VRZ1 formulations were each stored at a temperature of 4° C. for 24 hours prior to preparation.

Two coverslips were fixed on a slide, spaced by approximately 1 cm, with a drop of glass glue, and 5 μl of each homogenized mixture was added to the slide with a pipette. Then the slide was covered with another coverslip and sealed with glass glue. The individual samples were then immersed in liquid nitrogen for a few seconds to convert them to the glass transition state. The slides with sample were then vacuum sealed and stored at −22° C. for at least 48 hours for transition from the glass state to the crystalline state. At a constant temperature of −12° C., the recrystallization behavior was then studied by optical microscopy and the number of ice crystals was determined over time at a constant temperature of −12° C.

The homogenized mixtures on the slides were exposed to the following temperature parameters in a Linkam Peltier table PE 120-AFM® temperature control system, with the first crystal count being performed using Visicam Analyzer 5.0 camera software after the third cooling stage and repeated every 60 minutes thereafter. Temperature control from cooling levels 1 to 3 was performed at a cooling rate of 5° C./min with a hold time of 10 min per cooling level.

TABLE 1
Temperature parameters for ice crystal measurement

| | Temperature | Hold time |
|---|---|---|
| Cooling level | in ° C. | in min |
| 1 | −20 | 10 |
| 2 | −15 | 10 |
| 3 | −12 | 10 |
| 4 | −12 | 60 |
| 5 | −12 | 60 |
| 6 | −12 | 60 |
| 7 | −12 | 60 |
| 8 | −12 | 60 |

For determining the size of the ice crystals, the crystals were measured at regular intervals with the camera software Visicam Analyzer 5.0. Here, approximately 150 ice crystals per micrograph were measured and the medium ice crystal size was determined as diameter in μm. From the development of the ice crystal size, the ice crystal growth rate in μm/min could then be determined.

By measurement, the following values for the two formulations RZ1 and VRZ1 were obtained.

TABLE 2
Ice crystal growth rate

| | Formulation RZ1 | |
|---|---|---|
| | containing composition | Formulation VRZ1 |
| | Z1 according to | containing reference |
| | invention | composition VZ1 |
| Ice crystal growth | 0.06 | 0.2 |
| rate in μm/min | | |
| Premix viscosity in | 59.1 | 59.5 |
| mPa*s (D = 50 s⁻¹) | | |
| pH value | 4.3 | 4.7 |

For the formulation containing the composition Z1 according to the invention, an ice crystal growth rate of 0.06 μm/min was observed, while under the same conditions a significantly higher ice crystal growth rate of 0.2 μm/min was observed for a formulation containing the reference composition VZ1. The composition according to the invention can thus be used to noticeably slow down ice crystal growth, resulting in better storage stability and improved texture of ice cream.

In addition to ice crystal size, the percentage reduction in the number of ice crystals can also serve as a measure of storage stability. This is due to the fact that the reduction in ice crystals at a temperature of −12° C. is essentially due to Ostwald ripening and coalescence processes, i.e. the diffusion or coalescence of several smaller ice crystals into a smaller number of larger ice crystals. Thus, if an increased reduction in the number of ice crystals is observed in the cold test, this is related to a growth of ice crystals, which negatively affects the storage stability and texture of the ice cream.

TABLE 3
Reduction in the number of ice crystals

| | Reduction of number of | Reduction of number of |
|---|---|---|
| | ice crystals in % for | ice crystals in % for |
| | formulation RZ1 | formulation VRZ1 |
| Time in min | containing composition Z1 | containing composition VZ1 |
| 60 | 44 | 50 |
| 120 | 57 | 70 |
| 180 | 65 | 80 |
| 240 | 71 | 90 |
| 300 | 75 | 91 |

At a temperature of −12° C. over a period of 300 min, a decrease in the number of ice crystals of 91% was observed for the formulation containing the reference composition consisting of 50 wt. % locust bean gum and 50 wt. % guar gum, while a decrease in the number of ice crystals of 71% was observed for the formulation containing the composition according to the invention consisting of low-esterified, amidated soluble citrus pectin, high-esterified soluble citrus pectin and citrus fibers. Thus, the decrease in the number of ice crystals was significantly faster in the reference composition than in the composition according to the invention.

Consequently, the composition according to the invention was shown to produce higher storage stability than the commonly used ice cream stabilization system of locust bean gum and guar gum.

2.2 Melt-Off Behavior and Dimensional Stability

To characterize the melt-off behavior of ice cream, samples were placed on a perforated grid with a hole diameter of 10 mm and a regular spacing of 2 mm between the holes. The ice samples are melted at room temperature (23° C.), and the mass melted in the process is collected and balanced. The melting process is also photographed to document optical changes and thus compare the dimensional stability.

The melt-off behavior was analyzed for the following formulations:

TABLE 4
Formulations with low-esterified, amidated citrus pectin
and 11.3 wt. % fat for testing melt-off behavior

| | Formulation R1 | Reference |
|---|---|---|
| | according to | formulation |
| | the invention; | VR1; data |
| Ingredients | data in wt. % | in wt. % |
| Guar gum | — | 0.13 |
| Locust bean gum | — | 0.13 |
| Low-esterified, | 0.06 | — |
| amidated citrus pectin | | |
| (VE° = 37.4%, | | |
| A° = 11.3%) | | |
| Citrus fiber - | 0.11 | — |
| Herbacel ® - AQ ® Plus | | |
| Citrus-N (partially- | | |
| activated, activatable | | |
| citrus fiber) | | |
| High-esterified citrus | 0.05 | — |
| pectin (VE° = 68.6%) | | |
| Water | 59.5 | 59.54 |
| Coconut butter | 11.3 | 11.3 |
| Glucose-fructose syrup | 11.0 | 11.0 |
| (DE 68) | | |
| Sucrose | 9.08 | 9.0 |
| Skim-milk powder | 8.5 | 8.5 |
| Emulsifier: mono- and | 0.4 | 0.4 |
| diglycerides of fatty | | |
| acids | | |
| Premix viscosity in | 125 | 143 |
| mPa*s (D = 50 s⁻¹) | | |
| Overrun in % | 100 | 100 |
| pH value | 6.5 | 6.5 |

TABLE 5
Formulations with low-esterified citrus pectin and
11.3 wt. % fat for testing melt-off behavior

| | Formulation R2 | Reference |
|---|---|---|
| | according to | formulation |
| | the invention; | VR2; data |
| Ingredients | data in wt. % | in wt. % |
| Guar gum | — | 0.15 |
| Locust bean gum | — | 0.15 |
| Low-esterified citrus | 0.08 | — |
| pectin (VE° = 38.9%) | | |
| Citrus fiber - | 0.10 | — |
| Herbacel ® - AQ ® Plus | | |
| Citrus-N (partially- | | |
| activated, | | |
| activatable citrus | | |
| fiber) | | |
| High-esterified | 0.04 | — |
| citrus pectin | | |
| (VE° = 70.1%) | | |
| Water | 59.58 | 59.50 |
| Coconut butter | 11.3 | 11.3 |
| Glucose-fructose | 11.0 | 11.0 |
| syrup (DE 68) | | |
| Sucrose | 9.0 | 9.0 |
| Skim-milk powder | 8.5 | 8.5 |
| Emulsifier: mono- and | 0.4 | 0.4 |
| diglycerides of fatty | | |
| acids | | |
| Premix viscosity in | 249 | 264 |
| mPa*s (D = 50 s⁻¹) | | |
| Overrun in % | 100 | 100 |
| pH value | 6.5 | 6.5 |

For the preparation of the formulations, ⅔ of the water was first mixed with the skimmed milk powder using a hand blender and left to swell for 20 min. Then this mixture was heated with the other ingredients of each formulation to 85° C. in a pasteurizer Carpigiani Pastomaster 60 tronic with a capacity of 60 l, with a heating time from 30 to 40 min. The heated formulation was homogenized in two stages at 180/60 bar and then cooled to 4° C. in the pasteurizer. After reaching 4° C., the ripening time of the premix is 24 hours.

The freezing out of the ice cream mass was carried out in an ice cream machine with continuous mixing flow of 140 l/h from Gram Equipment GIF 600, at a pressure of 3 bar and a set air impact of 100% overrun, with an impact wave frequency not exceeding 700 rpm. The exit temperature of the partially frozen ice cream mass was −5° C. to −6° C.

The finished formulations were filled in and cured in a blast freezer at −40° C. The freezing rate of 0.6° C./min was measured until the target temperature of −22° C. was reached. Further storage of the formulations was then carried out at −22° C.

To investigate the melt-off behavior, 100 ml of ice cream mass with an average weight of 55 g of each of the formulations R1 and VR1 were placed on a perforated grid (hole diameter of 10 mm and a regular spacing between the holes of 2 mm). At a constant room temperature of 23° C., the dripping weight was determined gravimetrically over time.

TABLE 6
Results for the melt-off behavior of formulations
R1 and VR1; dripped ice cream mass in wt. %

| | Formulation R1 according | |
|---|---|---|
| | to the invention; | Reference formulation |
| | dripped ice cream mass | VR1; dripped ice cream |
| | in wt. % of the original | mass in wt. % of the |
| Time in min | ice cream mass | original ice cream mass |
| 20 | 0 | 0 |
| 40 | 0 | 4.0 |
| 60 | 0.6 | 17.0 |
| 80 | 0.9 | 27.0 |

TABLE 7
Results for the melt-off behavior of formulations
R2 and VR2; dripped ice cream mass in wt. %

| | Formulation R2 according | |
|---|---|---|
| | to the invention; | Reference formulation |
| | dripped ice cream mass | VR2; dripped ice cream |
| | in wt. % of the original | mass in wt. % of the |
| Time in min | ice cream mass | original ice cream mass |
| 20 | 0 | 0.5 |
| 40 | 0 | 5.4 |
| 60 | 0 | 16.7 |
| 80 | 0 | 33.7 |

It has been shown that the formulation according to the invention has an extraordinary and surprisingly high dimensional stability and that no significant melting can be observed even over very long time periods of more than one hour. Consequently, with the composition according to the invention, an ice cream with outstanding stability at ambient temperature can be obtained, which clearly outperforms the ice cream formulations known in the state of the art in terms of dimensional stability.

To ensure that the significantly improved melt-off behavior is not due to an altered fat morphology, the same experiment was repeated with a reduced fat content of 1.0 wt. % instead of 11.3 wt. %.

TABLE 6
Formulations with 1.0 wt. % fat for examining melt-off behavior

| | Formulation R3 | Reference |
|---|---|---|
| | according to | formulation |
| | the invention; | VR3; data |
| Ingredients | data in wt. % | in wt. % |
| Guar gum | — | 0.13 |
| Locust bean gum | — | 0.13 |
| Citrus fiber - | 0.11 | |
| Herbacel ® - AQ ® Plus | | |
| Citrus-N (partially- | | |
| activated, activatable | | |
| citrus fiber) | | |
| Low-esterified, | 0.06 | — |
| amidated citrus pectin | | |
| (VE° = 37.4%, A° = 11.3) | | |
| High-esterified citrus | 0.05 | — |
| pectin (VE° = 68.6%) | | |
| Water | 62.9 | 62.94 |
| Coconut butter | 1.0 | 1.0 |
| Glucose-fructose syrup | 11.0 | 11.0 |
| (DE 68) | | |
| Sucrose | 11.58 | 11.5 |
| Skim-milk powder | 13.0 | 13.0 |
| Emulsifier: mono- and | 0.3 | 0.3 |
| diglycerides of fatty | | |
| acids | | |
| Premix viscosity in | 61.5 | 99.8 |
| mPa*s (D = 50 s⁻¹) | | |
| Overrun in % | 100 | 100 |
| pH value | 6.5 | 6.5 |

Herein, preparation of the ice cream formulation and measurement of the dripped amount were performed in the same manner as for the formulations R1 and VR1.

TABLE 7
Results for the melt-off behavior of formulations
R3 and VR3; dripped ice cream mass in wt. %

| | Formulation R3 according | |
|---|---|---|
| | to the invention; | Reference formulation |
| | dripped ice cream mass | VR3; dripped ice cream |
| | in wt. % of the original | mass in wt. % of the |
| Time in min | ice cream mass | original ice cream mass |
| 10 | 0 | 0 |
| 20 | 0 | 3 |
| 30 | 6 | 13 |
| 40 | 14 | 29 |
| 50 | 29 | 51 |

At a fat content of 1.0 wt. %, both formulations exhibit accelerated melt-off behavior. However, also at this reduced fat content, the formulation R2 containing the composition according to the invention of low-esterified, amidated soluble pectin, high-esterified soluble pectin and plant fiber exhibited a significantly slower melt-off behavior than the reference formulation. Consequently, the advantageous effect of the composition according to the invention on dimensional stability could also be observed with a lower fat content.

Finally, it was also examined whether the temperature profiles of the formulations differed during the melt-off trial. Here, it was found that the temperature profile for formulation R1 did not differ from the temperature profile of reference formulation VR1. Therefore, the observed effects were not due to different ice crystal morphologies, either.

2.3 Sensory Perception

In the course of the comparative studies of the new composition Z1 according to the invention and the reference composition VZ1, it has surprisingly been found that the composition Z1 according to the invention can be employed in the ice cream in much larger weight percentages than was possible with the reference composition VZ1. The maximum possible amount of reference composition VZ1 in the ice cream was approximately 0.5 wt. %, referred to the total weight of the ice cream. Larger proportions of VZ1 in the ice cream impaired sensory perception of the ice cream substantially, leading to a slimy, unpleasant mouthfeel. In contrast, no negative effect on sensory perception of the ice cream could be observed with the composition Z1, even if amounts of over 2 wt. %, referred to the total weight of the ice cream, were used. A larger proportion of Z1 can be particularly advantageous in case of ice cream with reduced fat and/or sugar content.

3. Preparation of the Activated Pectin-Containing Citrus Fiber

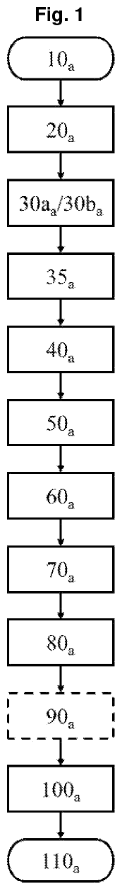

FIG. 1 is a schematic representation of a method of preparing the activated pectin-containing citrus fiber in the form of a flowchart. Starting from the citrus pomace 10ₐ, the pomace is solubilized by hydrolytic 20ₐ incubation in an acidic solution at 70° to 80° C. Two separate steps 30aₐ (decanter) and 30bₐ (separator) follow for as complete a separation of all particles from the liquid phase as possible. The separated material is washed with an aqueous solution 35ₐ. From the wash mixture thus obtained, coarse or non-solubilized particles are separated by wet screening. In step 40ₐ, the solids are then separated from the liquid phase. Then, two alcohol washing steps 50ₐ and 70ₐ are performed with subsequent solid-liquid separation by means of decanters 60ₐ and 80ₐ. In an optional step 90ₐ, any residual alcohol can be removed by blowing in water vapor. In step 100ₐ, finally, the fibers are gently dried by vacuum drying so as to obtain the citrus fibers 110ₐ.

4. Preparation of the Partially-Activated, Activatable Pectin-Containing Citrus Fiber

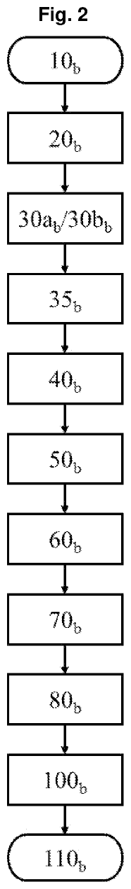

FIG. 2 is a schematic representation of a method of preparing the partially-activated, activatable pectin-containing citrus fiber in the form of a flowchart. Starting from the citrus pomace 10_{b}, the pomace is solubilized by hydrolytic 20_{b} incubation in an acidic solution at 70° to 80° C. Two separate steps 30a_{b} (decanter) and 30b_{b} (separator) follow for as complete a separation of all particles from the liquid phase as possible. The separated material is washed with an aqueous solution in step 35_{b}; from the wash mixture thus obtained, coarse or non-solubilized particles are separated by wet screening. In step 40_{b}, the solids are then separated from the liquid phase. Then, two alcohol washing steps 50_{b} and 70_{b} are performed with subsequent solid-liquid separation by means of decanters 60_{b} and 80_{b}. In step 100_{b}, finally, the fibers are gently dried by fluidized-bed drying so as to yield the citrus fibers 110_{b}.

5. Preparation of the Activated Pectin-Containing Apple Fiber

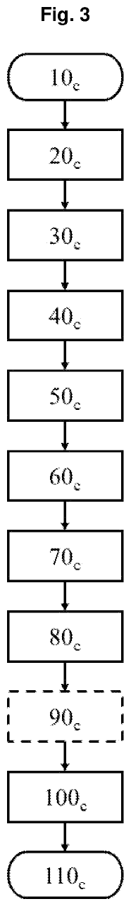

FIG. 3 is a schematic representation of a method of preparing the activated pectin-containing apple fiber in the form of a flowchart. Starting from the apple pomace 10_{c}, the pomace is solubilized by hydrolytic 20_{c} incubation in an acidic solution at 70° to 80° C. Then, the material is subjected, as an aqueous suspension, to a one- or multi-stage separation step 30_{c} for separating coarse particles, which subsequently entails a separation of the material, thus liberated from coarse particles, from the aqueous suspension (also part of step 30_{c}). In case of a multi-stage separation of coarse particles, this is preferably done with sieve drums of different sieve mesh widths. In step 40_{c}, the material liberated from coarse particles is washed with water and the washing liquid is separated off by means of solid-liquid separation. Subsequently, two alcohol washing steps 50_{c} and 70_{c} are performed, followed by solid-liquid separation 60_{c} and 80_{c} by means of a decanter. In an optional step 90_{c}, any residual alcohol can be removed by blowing in water vapor. In step 100_{c}, finally, the fibers are gently dried by vacuum drying so as to yield the apple fibers 110_{c}.

### LIST OF REFERENCE NUMBERS

FIG. 1
10ₐ, 10_{b} citrus pomace
10_{c} apple pomace
20ₐ, 20_{b}, 20_{c} hydrolysis (solubilization) by incubation in acidic environment
30aₐ, 30a_{b} 1^{st} solid-liquid separation decanter
30_{c} separation of coarse particles (one- or multi-stage) with separation of the cleaned material from the aqueous suspension
30bₐ, 30b_{b} 2^{nd} solid-liquid separation separator
35ₐ, 35_{b} wash mixture with wet sieving
40ₐ, 40_{b} solid-liquid separation
40_{c} washing with water and solid-liquid separation
50ₐ, 50_{b}, 50_{c} 1^{st} washing with alcohol
60ₐ, 60_{b}, 60_{c} solid-liquid separation decanter
70ₐ, 70_{b}, 70_{c} 2^{nd} washing with alcohol
80ₐ, 80_{b}, 80_{c} solid-liquid separation decanter
90ₐ, 90_{c} optional introduction of water vapor
100ₐ, 100_{c} vacuum drying
100_{b} fluidized-bed drying
110ₐ, 110_{b} obtained citrus fiber
110_{c} obtained apple fiber

1. A composition comprising:
a. plant fiber,
b. low-esterified soluble pectin,
c. high-esterified soluble pectin and
d. optionally, sugar.

2. The composition according to claim 1, wherein the low-esterified soluble pectin is a low-esterified amidated soluble pectin.

3. The composition according to claim 1, wherein the plant fiber is selected from the group comprising citrus fiber, apple fiber, sugar beet fiber, carrot fiber, pea fiber, the plant fiber preferably being a citrus fiber or an apple fiber.

4. The composition according to claim 1, wherein the sugar-containing composition comprises the plant fiber at a proportion of 20 to 50 wt. %, advantageously 30 to 40 wt. % and in particular 34 to 36 wt. %, referred to the total weight of the composition.

5. The composition according to claim 1, wherein the sugar-containing composition comprises the low-esterified soluble pectin, which is preferably a low-esterified amidated pectin and particularly preferably a low-esterified amidated soluble citrus pectin, at a proportion of 10 to 35 wt. %, preferably 15 to 30 wt. %, particularly preferably 20 to 25 wt. % and especially 22.5 wt. %, referred to the total weight of the composition.

6. The composition according to claim 1, wherein the sugar-containing composition comprises the high-esterified soluble pectin, which is preferably a high-esterified soluble citrus pectin, at a proportion of 5 to 30 wt. %, preferably 10 to 20 wt. %, particularly preferably 13 to 17 wt. % and especially preferably 15 wt. %, referred to the total weight of the composition.

7. The composition according to claim 1, wherein the sugar-containing composition contains the sugar at a proportion of 18 to 40 wt. %, preferably 20 to 38 wt. % and particularly preferably 23 to 32 wt. %, referred to the total weight of the composition.

8. The composition according to claim 7, wherein the sugar is selected from the group consisting of dextrose, sucrose, fructose, invert sugar, isoglucose, mannose, melezitose, glucose, allulose, maltose and rhamnose, the sugar preferably being dextrose or sucrose.

9. The composition according to claim 1, wherein the composition has an esterification degree of 40% to 60% and preferably 47% to 50% and/or an amidation degree of 5% to 10%, preferably 6% to 8%.

10. The composition according to claim 1, wherein the plant fiber has one or more of the following properties:
a. a dynamic Weissenberg index in a 2.5 wt. % suspension of more than 4.0, in particular more than 5.0;
b. a dynamic Weissenberg index in a 2.5 wt. % dispersion of more than 5.0, in particular more than 6.0;
c. a viscosity of 100 to 1200 mPas, preferably 350 to 950 mPas and particularly preferably 380 to 850 mPas, the plant fiber being dispersed in water as a 2.5 wt. % solution and the viscosity being measured at a shear rate of 50 s⁻¹ at 20° C.;
d. a water binding capacity of 20 to 34 g/g, preferably 22 to 30 g/g and particularly preferably 23 to 28 g/g;
e. a strength of more than 50 g;
f. a moisture content of less than 15%, preferably less than 10% and particularly preferably less than 8%;
g. in 1.0 wt. % aqueous suspension, a pH value of 3.1 to 5.0 and preferably 3.4 to 4.6;
h. a particle size where at least 90% of the particles are smaller than 300 μm;
i. a lightness value of L*>61 for apple fiber and L*>88 for citrus fiber;
j. a dietary fiber content of 80 to 95 wt. %;
k. the plant fiber being a depectinized plant fiber and preferably a depectinized fruit fiber;
l. the plant fiber containing less than 10%, preferably less than 8% and particularly preferably less than 6% of water-soluble pectin.

11. The composition according to claim 10, wherein the plant fiber is an activated pectin-containing citrus fiber having one or more of the following properties:
a. a yield strength II (rotation) in the fiber suspension of more than 1.5 Pa and advantageously more than 2.0 Pa;
b. a yield strength I (rotation) in the fiber dispersion of more than 5.5 Pa and advantageously more than 6.0 Pa;
c. a yield strength II (cross-over) in the fiber suspension of more than 1.2 Pa and advantageously more than 1.5 Pa;
d. a yield strength I (cross-over) in the fiber dispersion of more than 6.0 Pa and advantageously more than 6.5 Pa;
e. a dynamic Weissenberg index in the fiber suspension of more than 7.0, advantageously more than 7.5 and particularly advantageously more than 8.0;
f. a dynamic Weissenberg index in the fiber dispersion of more than 6.0, advantageously more than 6.5 and particularly advantageously more than 7.0;
g. a strength in a 4 wt. % aqueous suspension of at least 150 g, particularly advantageously at least 220 g;
h. a viscosity of at least 650 mPas, the plant fiber being dispersed in water as a 2.5 wt. % solution and the viscosity being measured at a shear rate of 50 s⁻¹ at 20° C.;
i. a water binding capacity of more than 22 g/g;
j. a moisture content of less than 15%, preferably less than 10% and particularly preferably less than 8%;
k. in 1.0 wt. % aqueous suspension, a pH value of 3.1 to 4.75 and preferably 3.4 to 4.2;
l. a particle size where at least 90% of the particles are smaller than 250 μm, preferably smaller than 200 μm and in particular smaller than 150 μm;
m. a lightness value L*>90, preferably L*>91 and particularly preferably L*>92;
n. a dietary fiber content of the fiber of 80 to 95%;
o. the activated pectin-containing citrus fiber containing less than 10%, advantageously less than 8% and particularly advantageously less than 6% of water-soluble pectin.

12. The composition according to claim 10, wherein the plant fiber is a partially-activated, activatable pectin-containing citrus fiber having one or more of the following properties:
a. a yield strength II (rotation) of the fiber suspension of 0.1-1.0 Pa, advantageously 0.3-0.9 Pa and particularly advantageously 0.6-0.8 Pa;
b. a yield strength I (rotation) in the fiber dispersion of 1.0-4.0 Pa, advantageously 1.5-3.5 Pa and particularly advantageously 2.0-3.0 Pa;
c. a yield strength II (cross-over) in the fiber suspension of 0.1-1.0 Pa, advantageously 0.3-0.9 Pa and particularly advantageously 0.6-0.8 Pa;
d. a yield strength I (cross-over) of the fiber dispersion of 1.0-4.5 Pa, advantageously 1.5-4.0 Pa and particularly advantageously 2.0-3.5 Pa;
e. a dynamic Weissenberg index in the fiber suspension of 4.5-8.0, advantageously 5.0-7.5 and particularly advantageously 7.0-7.5;
f. a dynamic Weissenberg index in the fiber dispersion of 5.0-9.0, advantageously 6.0-8.5 and particularly advantageously 7.0-8.0;
g. a strength in a 4 wt. % aqueous suspension of between 60 g and 240 g, preferably between 120 g and 200 and particularly preferably between 140 and 180 g;
h. a viscosity of 150 to 600 mPas, preferably 200 to 550 mPas and particularly preferably 250 to 500 mPas, the plant fiber being dispersed in water as a 2.5 wt. % solution and the viscosity being measured at a shear rate of 50 s⁻¹ at 20° C.;
i. a water binding capacity of more than 20 g/g, preferably more than 22 g/g and particularly preferably more than 24 g/g and especially preferably between 24 and 26 g/g;
j. a humidity of less than 15%, preferably less than 10% and particularly preferably less than 8%;
k. in 1.0 wt. % aqueous suspension, a pH value of 3.1 to 4.75 and preferably 3.4 to 4.2;
l. a particle size where at least 90% of the particles are smaller than 450 μm, preferably smaller than 350 μm and in particular smaller than 250 μm;
m. a lightness value L*>84, preferably L*>86 and particularly preferably L*>88;
n. a dietary fiber content of the fiber of 80 to 95%;
o. the activatable citrus fiber containing less than 10%, advantageously less than 8% and particularly advantageously less than 6% of water-soluble pectin.

13. The composition according to claim 10, wherein the plant fiber is an activated pectin-containing apple fiber having one or more of the following properties:
a. a yield strength II (rotation) in a fiber suspension of more than 0.1 Pa, advantageously more than 0.5 Pa and particularly advantageously more than 1.0 Pa;
b. a yield strength I (rotation) in the fiber dispersion of more than 5.0 Pa, advantageously more than 6.0 Pa and particularly advantageously more than 7.0 Pa;
c. a yield strength II (cross-over) in the fiber suspension of more than 0.1 Pa, advantageously more than 0.5 Pa and particularly advantageously more than 1.0 Pa;
d. a yield strength I (cross-over) in the fiber dispersion of more than 5.0 Pa, advantageously more than 6.0 Pa and particularly advantageously more than 7.0 Pa;
e. a dynamic Weissenberg index in the fiber suspension of more than 4.0, advantageously more than 5.0 and particularly advantageously more than 6.0;
f. a dynamic Weissenberg index in the fiber dispersion of more than 6.5, advantageously more than 7.5 and particularly advantageously more than 8.5;
g. a strength of more than 50 g, preferably more than 75 g and particularly preferably more than 100 g, the plant fiber being suspended in water as a 6 wt. % solution;
h. a viscosity of more than 100 mPas, preferably more than 200 mPas and particularly preferably more than 350 mPas, the plant fiber being dispersed in water as a 2.5 wt. % solution and the viscosity being measured at a shear rate of 50 s⁻¹ at 20° C.;
i. a water binding capacity of more than 20 g/g, preferably more than 22 g/g, particularly preferably more than 24 g/g and especially preferably more than 27.0 g/g;
j. a moisture content of less than 15%, preferably less than 8% and particularly preferably less than 6%;
k. in 1.0 wt. % aqueous suspension, a pH value from 3.5 to 5.0 and preferably 4.0 to 4.6;
l. a particle size where at least 90% of the particles are smaller than 400 μm, preferably smaller than 350 μm and especially smaller than 300 μm;
m. a lightness value L*>60, preferably L*>61 and particularly preferably L*>62;
n. a dietary fiber content of the fiber of 80 to 95%;
o. the apple fiber having less than 10%, advantageously less than 8% and particularly advantageously less than 6% of water-soluble pectin.

14. The composition according to claim 2, wherein the low-esterified amidated soluble pectin, which is preferably a low-esterified amidated soluble apple pectin or citrus pectin, has one or more of the following properties:
a. an esterification degree of 25 to 50%, preferably 29 to 45%, particularly preferably 34 to 40% and especially preferably 36 to 37.5%;
b. an amidation degree of 6 to 18%, preferably 8 to 17%, particularly preferably 10 to 16% and especially preferably 11 to 15%;
c. a calcium reactivity of 500 to 3000 HPE, preferably 700 to 2500 HPE, particularly preferably 1000 to 2000 HPE, especially preferably 1400 to 1700 HPE.

15. The composition according to claim 1, wherein the low-esterified soluble pectin, which is preferably a low-esterified soluble citrus pectin, has one or more of the following properties:
a. an esterification degree of 15 to 50%, preferably 25 to 48%, particularly preferably 30 to 46% and especially preferably 36 to 40%;
b. a calcium sensitivity of 200 to 3000 HPE, preferably 300 to 2500 HPE, particularly preferably 400 to 2000 HPE, especially preferably 500 to 1500 HPE.

16. The composition according to claim 1, wherein the low-esterified soluble pectin, which is preferably a low-esterified soluble apple pectin, has one or more of the following properties:
a. an esterification degree of 15 to 50%, preferably 25 to 48%, particularly preferably 30 to 46% and especially preferably 38 to 42%;
b. a calcium sensitivity of 200 to 2500 HPE, preferably 300 to 2000 HPE, particularly preferably 400 to 1500 HPE, especially preferably 500 to 1000 HPE.

17. The composition according to claim 1, wherein the high-esterified soluble pectin, which is preferably a high-esterified soluble citrus pectin or soluble apple pectin, has one or more of the following properties:
a. a degree of esterification of 60 to 80%, preferably 64 to 76%, particularly preferably 66 to 74% and especially preferably 68 to 70%;
b. a gelling power of 140 to 280° USA-Sag, preferably 160 to 260° USA-Sag and particularly preferably 170 to 250° USA-Sag.

18. The composition according to claim 1, wherein the composition has, in a 1.0 wt. % aqueous solution, a pH value of 3 to 5 and preferably 3.4 to 4.5.

19. The composition according to claim 1, wherein the composition is available in powder form.

20. A group consisting of one of an ice cream, low-calorie ice cream, plant-based ice cream or ice cream containing insect protein comprising the composition of claim 1.

21. The group of claim 20, wherein the composition being used as a semi-finished product or being produced as a composition in the final product by separate dosing of pectin-containing plant fiber and/or low-esterified, preferably amidated, soluble pectin and/or soluble high-esterified pectin.

22. Ice cream containing a composition according to claim 1, wherein the ice cream comprises one or more of the following ingredients:
a. an aqueous solution which is preferably milk and/or a milk product, the proportion of water in the ice cream being 20 to 80 wt. %, preferably 30 to 70 wt. %, particularly preferably 40 to 65 wt. % and especially preferably 50 to 65 wt. %, referred to the total weight of the ice cream;
b. a source of fat which is of plant or animal origin or a combination thereof, the fat content in the ice cream being preferably 0.5 to 30 wt. %, particularly preferably 0.5 to 20 wt. %, further preferably 0.5 to 15 wt. % and especially preferably 0.5 to 12 wt. %, referred to the total weight of the ice cream;
c. a source of protein which is of plant or animal origin or a combination thereof, the protein content in the ice cream being preferably 0.5 to 30 wt. %, particularly preferably 1 to 20 wt. %, further preferably 1 to 10 wt. %, especially preferably 2 to 5 wt. %, referred to the total weight of the ice cream;
d. sugar and/or a sugar substitute, the sugar content in the ice cream being preferably 5 to 50 wt. %, particularly preferably 8 to 40 wt. %, further preferably 10 to 30 wt. %, especially preferably 12 to 25 wt. %, referred to the total weight of the ice cream;
wherein, the ice cream contains a proportion of 0.05 to 1.5 wt. %, preferably 0.1 to 1.0 wt. %, particularly preferably 0.15 to 0.75 wt. % and especially preferably 0.2 to 0.5 wt. %, referred to the total weight of the ice cream.

23. Ice cream containing a composition according to claim 1, wherein the ice cream has one or more of the following properties:
a. an ice crystal growth rate of 0.001 to 10 μm/min, preferably 0.01 to 8 μm/min, particularly preferably 0.03 to 6 μm/min, especially preferably 0.04 to 2 μm/min, the temperature for determining the ice crystal growth being −12° C.;
b. within a time period of 300 min at a temperature of −12° C., a reduction in the number of ice crystals of 1 to 99%, preferably 10 to 90%, particularly preferably 20 to 90%, especially preferably 40 to 80%;
c. a melt-off rate of 0 g/min to 100 g/min, preferably 0 g/min to 80 g/min, particularly preferably 0 g/min to 50 g/min, especially preferably 0 g/min to 10 g/min, with 100 ml of ice cream being placed on a perforated grid with a hole diameter of 10 mm spaced by 2 mm over a time period of up to 80 min and the ambient temperature being 23° C. during the melt-off trial;
d. a freezing point of −0.1° C. to −15° C., preferably −0.1° C. to −12° C., particularly preferably −2° C. to −10° C. and especially preferably −2° C. to −5° C.;
e. a premix viscosity of 50 to 1200 mPas, preferably 100 to 950 mPas and particularly preferably 200 to 500 mPas, the viscosity of the premix being measured at a shear rate of 50 s⁻¹ at 4° C.;
f. a percentage of introduced air of 10% to 170%, preferably 40% to 140%, particularly preferably 50% to 120%, especially preferably 90% to 110%;
g. a proportion of destabilized fat of 1 to 50 wt. %, preferably 5 to 35 wt. %, particularly preferably 8 to 25 wt. %, especially preferably 10 to 20 wt. %, referred to the total fat content of the ice cream, the proportion of destabilized fat being measured at a single wavelength of 540 nm;
h. an average ice crystal diameter of 0.01 to 200 μm, preferably 0.1 to 150 μm, particularly preferably 0.1 to 100 μm, especially preferably 1 to 60 μm.

24. Ice cream according to claim 22, wherein the ice cream has a caloric value of 5 kcal to 500 kcal/100 g, preferably 10 kcal to 400 kcal/100 g, particularly preferably 40 kcal to 250 kcal/100 g, especially preferably 50 kcal to 150 kcal/100 g.

25. Ice cream containing a composition according to claim 1, wherein a plant-based ice cream and preferably comprising the following ingredients:
a) water;
b) a plant-based source of fat, such as coconut butter, palm oil, cocoa butter, nuts or cereals;
c) a plant-based source of protein, such as pea, hemp or soy; and
d) sugar and/or a sugar substitute.

26. The composition according to claim 22, wherein the protein source comprises a protein source made of insects or that the protein source consists of a protein source made of insects.

27. Method of preparing an ice cream comprising:
a. providing a composition according to claim 1;
b. optionally providing an aqueous solution which is preferably milk and/or a milk product;
c. optionally providing additional components, in particular a source of fat of plant or animal origin or a combination thereof; a protein source of plant or animal origin or a combination thereof, and/or a sugar and/or a sugar substitute;
d. combining, in particular mixing, the components provided in steps a. through c. in order to obtain a mixture;
e. heating the mixture obtained in step d. to a temperature of at least 60° C., in particular at least 80° C.;
f. homogenizing the mixture heated in step e., in particular by pressure homogenization;
g. cooling the mixture homogenized in step f. to approximately 4° C.;
h. allowing the mixture to ripen at 4 to 6° C.;
i. freezing out the mixture cooled in step g. to a temperature of less than −4° C.
